(19) United States
(12) Patent Application Publication
(10) Pub. No.: US 2023/0408070 A1
(43) Pub. Date: Dec. 21, 2023

(54) LUMINAIRE STRUCTURE

(71) Applicant: AXIS LIGHTING INC., Lasalle (CA)

(72) Inventors: Stephane BELAND, Lasalle (CA); Howard YAPHE, Lasalle (CA); Andrew MILES, Lasalle (CA); Nicolas POURRAIN, Lasalle (CA); Joel MCNABB-BALTAR, Lasalle (CA)

(21) Appl. No.: 18/242,369

(22) Filed: Sep. 5, 2023

Related U.S. Application Data
(63) Continuation-in-part of application No. 18/186,691, filed on Mar. 20, 2023.
Application No. 18/186,691 is a continuation-in-part of application No. 17/474,373, filed on Sep. 14, 2021, now Pat. No. 11,608,967.
Application No. 17/474,373 is a continuation-in-part of application No. 17/162,990, filed on Jan. 29, 2021, now Pat. No. 11,118,765.
Application No. 17/474,373 is a continuation-in-part of application No. 17/391,921, filed on Aug. 2, 2021, now Pat. No. 11,608,969.
Application No. 17/391,921 is a continuation-in-part of application No. PCT/CA2021/051071, filed on Jul. 29, 2021.
Application No. 18/186,691 is a continuation-in-part of application No. 17/718,167, filed on Apr. 11, 2022.
Application No. 17/718,167 is a continuation-in-part of application No. 17/306,855, filed on May 3, 2021, now Pat. No. 11,359,800.
Application No. 17/306,855 is a continuation of application No. 16/676,109, filed on Nov. 6, 2019, now Pat. No. 10,995,939.
Application No. 16/676,109 is a continuation of application No. 15/909,457, filed on Mar. 1, 2018, now Pat. No. 10,473,307.
Application No. 17/306,855 is a continuation-in-part of application No. 16/899,047, filed on Jun. 11, 2020, now Pat. No. 11,143,814.
Application No. 17/306,855 is a continuation-in-part of application No. 17/067,369, filed on Oct. 9, 2020, now Pat. No. 11,181,262.
Application No. 17/718,167 is a continuation-in-part of application No. 29/804,395, filed on Aug. 19, 2021.
Application No. 29/804,395 is a continuation-in-part of application No. 17/037,361, filed on Sep. 29, 2020, now Pat. No. 11,300,276.
Application No. 18/186,691 is a continuation-in-part of application No. 17/321,304, filed on May 14, 2021, now Pat. No. 11,635,190.
Application No. 17/321,304 is a continuation-in-part of application No. 16/004,057, filed on Jun. 8, 2018, now Pat. No. 11,199,002.
Application No. 16/004,057 is a continuation-in-part of application No. 29/615,179, filed on Aug. 26, 2017, now Pat. No. D926346.
Application No. 29/615,179 is a continuation-in-part of application No. 29/610,783, filed on Jul. 14, 2017, now Pat. No. D875988.
(60) Provisional application No. 63/374,540, filed on Sep. 3, 2022.
(60) Provisional application No. 62/985,205, filed on Mar. 4, 2020.
(60) Provisional application No. 62/532,970, filed on Jul. 14, 2017.
(60) Provisional application No. 62/521,795, filed on Jun. 19, 2017.
(60) Provisional application No. 62/859,922, filed on Jun. 11, 2019.
(60) Provisional application No. 62/991,535, filed on Mar. 18, 2020.
(60) Provisional application No. 62/991,535, filed on Mar. 18, 2020.
(60) Provisional application No. 62/532,977, filed on Jul. 14, 2017.

(51) Int. Cl. F21V 21/04; F21S 8/02

(52) U.S. Cl. CPC F21V 21/045; F21S 8/026; F21V 21/048; F21S 8/043

(57) ABSTRACT

Disclosed is a grid lighting system having at least one housing segment with at least one lighting zone. A lighting module is included that has at least one track lighting module and/or at least one non-track lighting module. The lighting zone extends along a first length of the housing segment having at least one first passage to receive the at least one lighting module. The housing segment includes a first power supply segment to be coupled with a designated line voltage outlet to deliver line voltage power to the lighting module in the lighting zone. Each lighting module includes a lighting subzone, with a second passage to receive one or more lighting submodules along a second length. A second power supply segment is provided to couple with the first power supply segment to receive line power and to deliver low voltage to the one or more lighting submodules.

### CROSS REFERENCE TO CO-PENDING APPLICATIONS

This application claims benefit of priority to U.S. Provisional App. No. 63/374,540, filed Sep. 3, 2022, and entitled LUMINAIRE STRUCTURE. In addition, this application is a Continuation-in-Part of U.S. patent application Ser. No. 18/186,691, filed Mar. 20, 2023, which is a Continuation-in-Part of U.S. patent application Ser. No. 17/474,373, filed Sep. 14, 2021 (U.S. Pat. No. 11,608,967), which is a Continuation-in-Part of U.S. patent application Ser. No. 17/162,990, filed Jan. 29, 2021 and entitled LUMINAIRE STRUCTURE (U.S. Pat. No. 11,118,765), and is a Continuation-in-Part of U.S. patent application Ser. No. 17/391,921, filed Aug. 2, 2021 (U.S. Pat. No. 11,608,969), which is a Continuation-in-Part of U.S. patent application Ser. No. 17/162,990, filed Jan. 29, 2021 (U.S. Pat. No. 11,118,765) and is a Continuation-in-Part of International Patent Application No. PCT/CA2021/051071, filed Jul. 29, 2021. In addition, U.S. patent application Ser. No. 17/162,990, filed Jan. 29, 2021, claims the benefit of priority to U.S. Provisional App. No. 62/985,205, filed Mar. 4, 2020. The disclosures referenced above are herein incorporated by reference in their entireties.

This application is also a Continuation-in-Part of copending U.S. patent application Ser. No. 17/718,167, filed Apr. 11, 2022, which is a Continuation-in-Part of U.S. application Ser. No. 17/306,855, filed May 3, 2021, which is a Continuation of U.S. application Ser. No. 16/676,109, filed Nov. 6, 2019 (now U.S. Pat. No. 10,995,939), which is a Continuation of U.S. application Ser. No. 15/909,457, filed Mar. 1, 2018 (Now U.S. Pat. No. 10,473,307), which claims the benefit of priority under 35 U.S.C. § 119(e) to U.S. Provisional Patent Application No. 62/521,795, filed Jun. 19, 2017, and U.S. Provisional Patent Application No. 62/532,970, filed Jul. 14, 2017; U.S. application Ser. No. 17/306,855 is also a Continuation-in-Part of co-pending U.S. application Ser. No. 16/899,047, filed Jun. 11, 2020, which claims the benefit of priority under 35 U.S.C. § 119(e) to U.S. Provisional Patent Application No. 62/859,922, filed Jun. 11, 2019, and to U.S. Provisional Patent Application No. 62/991,535, filed Mar. 18, 2020; U.S. application Ser. No. 17/306,855 is also a Continuation-in-Part of U.S. application Ser. No. 17/067,369, filed Oct. 9, 2020, which claims the benefit of priority under 35 U.S.C. § 119(e) to U.S. Provisional Patent Application No. 62/991,535, filed Mar. 18, 2020; U.S. application Ser. No. 17/718,167 is also a Continuation-in-Part of copending U.S. application Ser. No. 17/037,361, filed Sep. 29, 2020 (now U.S. Pat. No. 11,300,276), and a Continuation-in-Part of U.S. Design Application No. 29/804,395, filed Aug. 19, 2021.

This application is also a Continuation-in-Part of copending U.S. patent application Ser. No. 17/321,304, filed May 14, 2021, which is a Continuation-in-Part of U.S. patent application Ser. No. 16/004,057, filed Jun. 8, 2018 (now U.S. Pat. No. 11,199,002), which claims the benefit of priority under 35 U.S.C. § 119(e) to U.S. Provisional Patent Application No. 62/532,977, filed Jul. 14, 2017. U.S. application Ser. No. 16/004,057 is also a Continuation-in-Part of U.S. Design Application No. 29/610,783, filed Jul. 14, 2017 (now Pat. No. D875,988) and is a Continuation-in-Part of U.S. Design Application No. 29/615,179, filed Aug. 26, 2017. The disclosures referenced above are also herein incorporated by reference in their entireties.

Additionally, the disclosures set forth in the following applications are incorporated herein by reference in their entireties:
U.S. patent application Ser. No. 16/795,153, filed Feb. 19, 2020 and entitled COUPLERS FOR LIGHT FIXTURES, U.S. Pat. No. 11,079,082;
U.S. patent application Ser. No. 15/299,168, filed Oct. 20, 2016 and entitled COUPLERS FOR LIGHT FIXTURES, now granted as U.S. Pat. No.
U.S. patent application Ser. No. 16/256,356, filed Jan. 24, 2019 and entitled COUPLERS FOR LIGHT FIXTURES, now granted as U.S. Pat. No. 10,584,857;
U.S. Provisional App. No. 62/820,083 filed Mar. 18, 2019 and entitled MOUNT INTERFACE FOR LIGHT FIXTURES;
U.S. patent application Ser. No. 16/723,665 filed Dec. 20, 2019 and entitled MOUNT INTERFACE FOR LIGHT FIXTURES U.S. Pat. No. 11,092,319; and
U.S. Provisional App. No. 62/985,205, filed Mar. 4, 2020 and entitled LUMINAIRE

### FIELD OF THE DISCLOSURE

The present disclosure relates to luminaire structures and associated structures.

### BACKGROUND

Traditionally, grid lighting systems deploy a grid of track segments which are configured to deliver power to a collection of lighting modules, to deliver lighting to a space.

Considerable effort is involved in the installation of such grid lighting systems so that, once installed, the actual configuration of lighting modules can safely be changed by a user. This is done by delivering “low voltage”, such as that specified as Class 2 UL, along the entire grid lighting system, to be coupled with “low voltage” lighting modules.

In such configurations, each of the track segments is usually supplied with an array of dedicated “low voltage” supply “line drops” appearing at relatively short intervals, such as at every 8 feet, along the grid lighting system. Moreover, each “low voltage” supply line is usually supplied by a “remote” power supply, which may power one or several of such “low voltage” supply lines. This usually requires a dedicated utility space, remote from the grid lighting system itself, to be set aside to locate the power supplies, along with considerable lengths of power cabling to and from each power supply to its one or several designated “low voltage” line drops. Thus, the larger the area occupied by the grid lighting system, the larger the power supply infrastructure required to allow it to function in the manner intended, with a corresponding increasing overhead expense as a result.

U.S. Application US 2018/0313503 discloses a modular canopy lighting system is described comprising suspension elements for suspending said system from a ceiling, power beams including internal power beams, and connectors for connecting beams with other beams and beams with suspenders and lighting elements.

It would thus be desirable to provide novel approaches for grid lighting systems, or at least to provide the public with one or more useful alternatives.

### SUMMARY

In an aspect, there is provided a grid lighting system, comprising: at least one housing segment with at least one lighting zone. At least one lighting module is selected from at least one track lighting module and/or at least one non-track lighting module. The at least one lighting zone extends along a first length dimension of the housing segment and including at least one first passage to receive the at least one track lighting module and/or non-track lighting module therein. The housing segment includes a first power supply segment to be coupled with a designated line voltage outlet to deliver line voltage power to the at least one lighting module in the at least one lighting zone. Each track lighting module includes a lighting subzone, with a second passage therein to receive one or more lighting submodules along a second length dimension, and a second power supply segment to couple with the first power supply segment to receive line voltage power therefrom and to deliver low voltage power to the one or more lighting submodules.

The system may further comprise at least one hub segment to join with the at least one housing segment to form a grid configuration.

The first power supply segment may include one or more line voltage outlet plugs spaced along the first length dimension.

A group of one or more of the line voltage outlet plugs may be each mounted on a corresponding cable to engage a matching line voltage inlet plug in the corresponding lighting module.

At least one, or each of the one or more lighting submodules may include a class 2 driver, or other driver, and the second power supply segment is configured to deliver substantially constant voltage thereto.

At least one, or each non-track lighting module may include a constant current driver.

The at least one lighting zone may include a direct lighting zone and/or an indirect lighting zone.

The at least one lighting module may include a plurality of lighting modules, which may include a direct group of one or more lighting modules and/or an indirect group of one or more lighting modules. Each lighting module may include a sub-structure which may be configured to fit exclusively in a corresponding direct passage in the direct lighting zone or an indirect passage in the indirect lighting zone.

At least one, or each lighting module in the direct group may have at least one dimension and/or formation which may differ from a corresponding at least one dimension and/or formation of each lighting module in the indirect group.

The first power supply segment may be configured to receive the line voltage power at a voltage of from about 120 volts to about 277 volts at 60 watts.

The second power supply segment may be configured to deliver the low voltage at a voltage of about 12 to about 48 volts at 60 watts.

The first length dimension may be substantially in line and/or coplanar with the second length dimension.

In another aspect, there is provided a grid lighting system, comprising: at least one elongate support structure defining at least one lighting zone, and at least one lighting module selected from at least one track lighting module and/or at least one non-track lighting module. The at least one lighting zone is configured to extend along a length dimension of the elongate support structure and to receive the at least one lighting module. The elongate support structure is associated with a first power supply segment to deliver line voltage power to the at least one lighting module in the at least one lighting zone. Each track lighting module includes a lighting subzone extending along a length dimension thereof, to receive one or more lighting submodules therein, and a second power supply segment to couple with the first power supply segment to deliver low voltage power to the at least one lighting submodule in the lighting subzone. The first power supply segment is configured in a first mode to deliver line voltage power to the at least one lighting module, and in a second mode to cooperate with the second power supply segment in the at least one track lighting module to deliver low voltage power to the at least one lighting submodule.

In another aspect, there is provided a kit for assembling a grid lighting network, comprising: a plurality of grid segments configured to be assembled to form a grid network defining a plurality of mounting sectors for supporting each of a plurality of lighting modules. At least one first power supply segment is to be coupled to a line voltage outlet to deliver line voltage power to each mounting sector in at least one power delivery zone in the grid network and which is defined by: a designated number of the plurality of mounting sectors; and a designated number of the plurality of lighting modules, each configured for mounting in the at least one power delivery zone at one of the designated number of mounting sectors. The at least one power delivery zone is configured according to a combined lighting unit power rating for the power delivery zone to approach but not exceed a maximum power delivery rating of the line voltage outlet, to enable any one of the designated number of lighting modules to be moved from one of the mounting sectors to another in the designated number thereof, and still comply with the maximum power delivery rating of the line voltage outlet. The designated number of lighting modules is selected from one or more track lighting modules and/or one or more non-track lighting modules.

In another aspect, there is provided a method for preparing a configured installation of a grid lighting network in a target space, comprising:
providing a plurality of grid segments configured to be assembled into the grid lighting network for supporting each of a plurality of interchangeable lighting modules at a corresponding one of a plurality of mounting sectors defined thereon,
allocating the plurality of grid segments to a first power delivery zone defined by:
   i. a designated number of mounting sectors along the first power delivery zone; and
   ii. a designated number of the interchangeable lighting modules, each for mounting at any one of the designated number of mounting sectors in the first power delivery zone;
providing at least one first power supply segment to be coupled to a first designated line voltage outlet to deliver line voltage power to each of the designated number of mounting sectors in the first power delivery zone; and
configuring the designated number of mounting sectors along the first power delivery zone according to a first combined lighting unit power rating for the first power delivery zone to approach but not exceed a maximum power delivery rating of the first line voltage outlet; to enable any one of the designated number of interchangeable lighting modules to be moved from one mounting sector to another mounting sector in the designated number thereof, and still comply with the maximum power delivery rating of the first line voltage outlet; and
selecting the designated number of interchangeable lighting modules from one or more track lighting modules, or one or more non-track lighting modules.

The method may further comprise configuring each of the one or more track lighting modules, or one or more non-track lighting modules to deliver low voltage power to at least one array of LEDs associated therewith.

In another aspect, there is provided a kit for assembling a lighting system, comprising a plurality of grid segments configured to be assembled into a grid network for supporting a plurality of interchangeable lighting modules at a plurality of mounting sectors defined by the grid network. Also provided is a power supply segment to be coupled to a designated line voltage outlet to deliver line voltage power to each of the mounting sectors in a designated power delivery zone in the grid network defined by: a designated number of the plurality of mounting sectors in the designated power delivery zone; and a designated number of the plurality of interchangeable lighting modules for mounting in the designated power delivery zone. The designated power delivery zone is configured to define a combined lighting unit power rating to approach a maximum power delivery rating of the designated line voltage outlet, wherein the designated number of the plurality of interchangeable lighting modules is selected from one or more track lighting modules or one or more non-track lighting modules.

In another aspect, there is provided a kit for assembling a grid lighting network, comprising: a first plurality of grid segments, each configured to be assembled to form the grid lighting network and to define a second plurality of mounting sectors therein, with each mounting sector configured to operatively couple with a corresponding one of a third plurality of lighting modules. At least one first power supply segment is configured to be associated with the grid lighting network and to be coupled to a first line voltage outlet to deliver line voltage power to each of the mounting sectors in at least one first power delivery zone in the grid lighting network, wherein the at least one first power delivery zone is defined by: a designated first number of the second plurality of mounting sectors; and a designated first number of the third plurality of lighting modules. The at least one first power delivery zone is configured according to a first combined lighting unit power rating for the first power delivery zone to approach but not exceed a maximum power delivery rating of the first line voltage outlet, to enable any one of the designated first number of lighting modules to be moved from one of the mounting sectors in the designated first number thereof to another of the mounting sectors in the designated first number thereof, and still comply with the maximum power delivery rating of the first line voltage outlet. The designated first number of lighting modules is selected from one or more track lighting modules and/or one or more non-track lighting modules.

The kit may further comprise a plurality of hub structures to couple the first plurality of grid segments together to form the grid lighting network.

The kit may further comprise the first number of lighting modules.

The at least one first power supply segment may include one or more line voltage outlet plugs spaced along each mounting sector of the designated first number thereof.

At least one, or each of a group of one or more of the line voltage outlet plugs may be mounted on a corresponding cable segment to engage a complementary line voltage inlet plug in the corresponding lighting module.

Each track lighting module of the designated first number of lighting modules may be configured to receive one or more lighting submodules, wherein each lighting submodule may include one or more arrays of one or more LEDs, and a submodule driver. Each track lighting module may further comprise a second power supply segment configured to deliver low voltage power to the submodule driver.

The submodule driver may be a class 2 driver or another driver.

At least one, or each non-track lighting module in the first number of lighting modules may include one or more arrays of one or more LEDs, and a constant current driver to deliver substantially constant current thereto.

At least one, or each non-track lighting module may further comprise a first power controller segment for controlling a first power level of output power to be delivered by the constant current driver to the one or more arrays of one or more LEDs.

The first power controller segment may be configured to be addressable in a wired and/or wireless network to receive commands to set the first power level.

The first power controller segment may be configured to communicate with a first wireless sensor segment to exchange signals on the wireless network.

The non-track lighting module may include a passage to receive the first wireless sensor segment.

The second power supply segment may further comprise a second power supply and a second power controller segment for controlling a second power level of output power to be delivered by the second power supply to the one or more lighting submodules.

The second power controller segment may be configured to be addressable in a wired and/or wireless network to receive commands to set the second power level.

The second power controller segment may be configured to communicate with a second wireless sensor segment, to exchange signals in the wireless network.

The non-track lighting module may include a passage to receive the second wireless sensor segment.

A designated first number of one or more of the first plurality of grid segments may be configured to provide at least one lighting zone, wherein the at least lighting zone includes at least one direct lighting zone and/or an indirect lighting zone.

The at least one first power supply segment may be configured to receive the line voltage power at a voltage of from about 120 volts to about 277 volts at 60 watts.

The second power supply segment may be configured to deliver the low voltage at a voltage of from about 12 to about 48 volts at 60 watts.

The at least one first power supply segment may comprise a plurality of first power supply segments, with at least one, or each thereof integrated into a corresponding grid segment. At least one, or each of the first power supply segments may be configured to be electrically coupled with one or more adjacent first power supply segments in the grid network at a corresponding hub structure.

In another aspect, there is provided a lighting system comprising at least one grid network configured to provide a plurality of mounting sectors therein and to deliver line voltage power to each of the mounting sectors from a single line voltage power source, each of the mounting sectors configured to receive at least one track lighting module and/or at least one non-track lighting module for delivery of light to an interior space adjacent the at least one grid network, each of the at least one track lighting module and/or at least one non-track lighting module being operatively associated with one or more arrays of one or more LEDs, and each of the at least one track lighting module and/or at least one non-track lighting module being configured to receive the line voltage power from a corresponding mounting sector and to deliver low voltage power to the one or more arrays of one or more LEDs associated therewith.

At least one, or each of the track lighting modules may be configured to receive one or more lighting submodules. At least one, or each lighting submodule may include at least one of the one or more arrays of one or more LEDs, and a submodule driver. At least one, or each track lighting module may further comprise a second power supply segment which may be configured to deliver the low voltage power to the submodule driver to power the at least one of the one or more arrays of one or more LEDs.

The grid network may further comprise a plurality of standardized grid segments which may be configured for assembly in any one of a plurality of grid network configurations, such that any one of the track lighting modules and/or any one of the non-track lighting modules may be engageable with any one of the mounting sectors.

The grid network may further comprise a plurality of standardized hub segments for interconnecting the plurality the standardized grid segments.

One or more of the grid segments may include a housing segment structure, at least one, or each of which may define a first channel to define at least one mounting sector. The track lighting module and/or non-track lighting module may be removably secured therein.

The system may further comprise a first power supply segment associated with the housing structure for delivering the line voltage power to the mounting sector. The track lighting module and/or non-track lighting module may include a second power supply segment to receive the line voltage power and to deliver low voltage power to the array.

At least one, or each of the at least one track lighting module and/or the at least one non-track lighting module may include one or more releasable locking structures to removably lock the corresponding track lighting module and/or non-track lighting modules in the first channel.

The track lighting module may be configured to be received in the first channel in a configuration to receive the one or more lighting submodules.

The track lighting module may include a track structure defining a second channel, and/or the lighting submodule may include coupling structure to be received by the track structure in the second channel in an operative position wherein the track structure and the coupling structure are configured to deliver the low voltage power to the lighting submodule.

The coupling structure may include a power supply segment to deliver a second low voltage power to the array.

The lighting submodule may include bridging structure to enable electrical connections between the coupling structure and the at least one array.

The system may further comprise mounting structure to releasably mount the lighting submodule to the housing structure with the coupling structure in the operative position.

The mounting structure may include at least one arm which may be configured to extend along a corresponding boundary of the housing structure and a retaining structure to releasably engage the arm and the housing structure.

The mounting structure may include a pair of arms which may be configured to extend along opposite boundaries of the housing structure, and/or the retaining structure is configured to releasably engage at least one of the arms and the housing structure.

The lighting submodule may further comprise anchoring structure to anchor at least one pendant or non-pendant light fixture thereto containing at least one of the one or more arrays.

The non-track lighting module may be configured to be received in the first channel in a configuration to anchor at least one pendant or non-pendant light fixture thereto containing at least one of the one or more arrays.

The non-track lighting module may include a coupling structure to be received in the first channel and which may be configured to receive the line voltage power from the mounting sector and to deliver the low voltage power to the at least one pendant or non-pendant light fixture thereto.

The non-track lighting module may include bridging structure to enable electrical connections between the coupling structure and the at least one pendant or non-pendant light fixture.

The one or more releasable locking structures may include one or more latches movable between a released position and a locking position, and/or the locking position the one or more latches may engage a complementary stop segment associated with the housing segment structure adjacent the first channel.

The least one grid network may be configured so that any one of the one or more mounting sectors may be addressable in a wired and/or wireless network to receive operational commands for delivering the line voltage power to the at least one track lighting module and/or at least one non-track lighting module.

The at least one track lighting module and/or at least one non-track lighting module may be configured to be addressable in a wired and/or wireless network to receive operational commands for controlling the lower voltage power to be delivered to the one or more arrays of one or more LEDs.

The first and/or second power supply segments may be configured to be addressable in a wired and/or wireless network to receive operational commands for controlling the corresponding line voltage power to be delivered to the at least one track lighting module and/or at least one non-track lighting module, and/or the corresponding low voltage power to be delivered to the one or more arrays of one or more LEDs.

In another aspect, there is provided an assembly for installing a lighting submodule in a housing structure of a grid lighting system, comprising at least one arm configured to extend along a corresponding boundary of the housing structure and a retaining structure to releasably engage the arm and the housing structure.

The at least one arm may include a pair of arms configured to extend along opposite boundaries of the housing structure, and the retaining structure is configured to releasably engage at least one of the arms and the housing structure.

The lighting submodule may further comprise anchoring structure to anchor at least one pendant or non-pendant light fixture thereto containing at least one array of one or more LEDs.

The lighting submodule may include a track lighting submodule, to engage a tracking lighting module located in the housing structure.

In another aspect, there is provided a method, kit, device, network, module and/or structure as described herein.

In another aspect, there is provided a grid lighting system, comprising:
a. at least one housing segment with at least one lighting zone,
b. at least one lighting module selected from at least one track lighting module and/or at least one non-track lighting module;
c. the at least one lighting zone extending along a first length dimension of the housing segment and including at least one first passage to receive the at least one track lighting module and/or non-track lighting module therein;
d. the housing segment including a first power supply segment to be coupled with a designated line voltage outlet to deliver line voltage power to the at least one lighting module in the at least one lighting zone; and
e. each track lighting module including a lighting subzone, with a second passage therein to receive one or more lighting submodules along a second length dimension, and a second power supply segment to couple with the first power supply segment to receive line voltage power therefrom and to deliver low voltage power to the one or more lighting submodules.

The at least one housing segment may be configured to be suspended in a first position below the ceiling structure, to be positioned in a second position adjacent a facing surface defined by the ceiling structure, or to be positioned in a third position within the ceiling structure with the at least one lighting zone accessible adjacent the facing surface.

The grid lighting system may further comprise an anchor structure for securing the at least one housing segment in any one of the first, second and third positions.

The lighting module may include at least one light delivery structure configured to be directed deliver light to a designated region in an interior space.

The lighting module may include a pair of the light delivery structures configured to be directed deliver light to respective designated regions in the interior space.

The pair of light delivery structures may be configured to deliver light at opposed angles relative to a vertical axis.

The opposed angles may be substantially equal relative to a vertical axis.

The at least one housing segment may include a pair of opposed first locating flanges for locating adjacent corresponding boundaries of a designated opening in the facing surface to receive the housing segment.

The at least one lighting module may include a pair of opposed second locating flanges, each of which is configured to be located adjacent a corresponding first locating flange when in an operative position in the at least one lighting zone.

In an aspect, there is provided a modular lighting segment structure for use in assembling in a series of at least two thereof for a grid lighting system, comprising:
at least one transfer structure extending along a length dimension thereof, the at least one transfer structure having at least two end regions;
at least one pair of first modular junction structures associated with a corresponding one of the at least one transfer structure and in power transferring relation therewith, wherein each one of the at least one pair of first modular junction structures is accessible adjacent the transfer structure, and is configured to be in power transferring relation with a modular junction structure on a transfer structure of at least one of an adjacent modular lighting segment structure and an adjacent supply structure;
at least one group of first transfer channels extending along the at least one transfer structure, and configured to be in power transferring relation with, one pair of the at least one pair of first modular junction structures; and
at least one first modular sub-junction structure configured to be in power transferring relation with at least one of:
   a corresponding group of the at least one group of first transfer channels to exchange line voltage power therewith;
   at least one first modular lighting structure, or at least one first lighting accessory to be associated with the modular lighting segment structure;
   the adjacent supply structure to receive line volage power therefrom; and
   another structure associated with the modular lighting segment structure.

One or more of the first modular junction structures may each be accessible adjacent a corresponding end region.

At least two of the at least one group of first transfer channels may be configured to be in at least one of a power transferring relation and a signal transferring relation with at least one of the of the first modular junction structures.

The at least one group of first transfer channels may extend between at least one pair of the at least one pair of first modular junction structures.

The at least one group of first transfer channels may include at least one power transfer channel and at least two signal transfer channels.

At least one first driver structure may be associated with one of the at least one transfer structure, wherein the at least one first driver structure is configured to be in power and/or signal transferring relation with at least one of the first modular sub-junction structures.

At least one transfer structure may include at least one board structure, wherein the at least one group of first transfer channels may include a plurality of conductive pathways applied to the at least one board structure.

At least one transfer structure may be configured to transfer power and signals therealong.

The first transfer channels may include a plurality of power transfer channels and a plurality of signal transfer channels.

The modular lighting segment structure may further comprise:
at least one group of second transfer channels extending along the at least one transfer structure and configured to be in power transferring relation with one pair of the at least one pair of first modular junction structures; and
one or more second modular sub-junction structures to be in power transferring relation with at least one of:
   a corresponding group of the at least one group of first and/or second transfer channels,
   at least one second modular lighting structure, or at least one second lighting accessory to be associated with the modular lighting segment structure, and;
   another structure at least one of onboard and offboard the modular lighting segment structure.

The at least one transfer structure may include at least one board structure, wherein at least one of the at least one group of first transfer channels and the at least one group of second transfer channels are in the form of conductive pathways applied to the at least one board structure.

At least one of the at least one first modular lighting structure and the at least one second modular lighting structure respectively may include at least one of the at least one first driver structure and at least one second driver structure configured to be associated with the at least one transfer structure, and to be in at least one of a power transferring relation and a signal transferring relation with a corresponding at least one of the first and second modular sub-junction structures.

In an aspect, there is provided a modular lighting segment structure assembly, comprising at least two modular lighting segment structures as defined herein.

In an aspect, there is provided a kit to assemble a modular lighting segment assembly, comprising at least a pair of modular lighting segment structures as defined herein, and a jumper structure, wherein:
a. a first of the pair, as a host modular lighting segment structure, is configured with a driver structure, and:
   to deliver line voltage power from the adjacent supply structure to the driver structure directly or indirectly via one of the first modular junction structures thereon;
   to deliver low voltage power from the driver structure to at least one LED array associated with the first modular lighting segment structure; and
   to deliver the line voltage power and/or the low voltage power to second of the pair, and wherein;
b. the second of the pair, as a client modular lighting segment structure, is configured to receive at least one of the line power and the low voltage power at a first modular junction structure thereon via the jumper structure between respective first modular junction structures on the host and client modular lighting segment structures, and to deliver the low voltage power to at least one LED array associated with the host modular lighting segment structure and/or the client modular lighting segment structure.

The client modular lighting segment structure may be configured to deliver the at least one of the line voltage power and the low voltage power to another of the first modular junction structures on the client modular junction structure, so as to transfer the at least one of the line voltage power and the low voltage power to another modular lighting segment.

The other structure associated with the modular lighting segment structure may be onboard the modular lighting segment structure.

The other structure associated with the modular lighting segment structure may be offboard the modular lighting segment structure.

The at least two end regions are at least one of spaced apart, opposed and adjacent.

In an aspect, there is provided a modular lighting segment structure for use in multiples of least two thereof, for use in one or more lighting modules, to deliver line voltage power and/or communication signals thereto, when operable in a corresponding one or more mounting sectors in a grid lighting system, the modular lighting segment structure comprising:
at least one transfer structure having at least two end regions, and including a plurality of transfer channels extending therealong, with one or more thereof configured to transfer line voltage power and/or communications signals;
at least one pair of first modular junction structures, each configured to be accessible adjacent a respective one of the end regions, and configured to be in line voltage power and/or signal transferring relation with corresponding ones of the transfer channels, wherein each one of the at least one pair of first modular junction structures is configured to be in direct or indirect line voltage power transferring relation with at least one of a modular junction structure associated with a transfer structure of at least one adjacent modular lighting segment structure, and an adjacent line voltage power and/or communications signal supply structure associated with at least one of the mounting sectors;
at least one modular sub-junction structure configured to be in line voltage or low voltage power transferring relation with at least one of:
a corresponding plurality of the at least one group of the plurality of transfer channels;
at least one LED array associated with a corresponding lighting module, or at least one lighting accessory to be associated with the lighting module;
the adjacent supply structure; and
another structure associated with the modular lighting segment structure.

In an aspect, there is provided a modular lighting segment structure for use in multiples of least two thereof, for use in one or more lighting modules, to transfer line voltage power and/or signals therewith, when operable in a corresponding one or more mounting sectors in a grid lighting system, the modular lighting segment comprising:
at least one transfer structure with a plurality of transfer channels extending between at least two end regions thereof to transfer power and/or signals;
at least two modular junction structures, each configured to be accessible adjacent a respective end region, to be in power and/or signal transferring relation with corresponding transfer channels, wherein each one of the at least one pair of modular junction structures is configured to be in direct or indirect line voltage power and/or signal transferring relation with at least one of a modular junction structure on a transfer structure of at least one of an adjacent modular lighting segment structure, and an adjacent line voltage power and/or signal supply structure associated directly or indirectly with at least one of the mounting sectors;
at least one modular sub-junction structure configured to be in line voltage or low voltage power and/or signal transferring relation with at least one of:
a corresponding group of the plurality of transfer channels;
at least one modular lighting structure, at least one LED array associated with the corresponding lighting module or the modular lighting structure, or at least one lighting accessory to be associated with one of the one or more lighting modules;
the adjacent supply structure; and
another structure associated with the modular lighting segment structure.

One or more of the modular junction structures may each be accessible adjacent a corresponding end region.

At least two of the plurality of transfer channels may be configured to be in at least one of a line voltage power transferring relation and a signal transferring relation with at least one of the of the modular junction structures.

At least one group of plurality of the transfer channels may extend between at least two of the at least one pair of first modular junction structures.

Theat least one group of transfer channels may include at least two line voltage power transfer channels and at least two signal channels.

The at least one modular lighting structure may include at least one driver structure to be associated with one of the at least one transfer structure, wherein the at least one driver structure may be configured to be in line voltage or low voltage power and/or signal transferring relation with at least one of the first modular sub-junction structures.

The at least one transfer structure may include at least one board structure, wherein the plurality of transfer channels may include a plurality of conductive pathways applied to the at least one board structure.

The transfer channels may include a plurality of line voltage power transfer channels, a plurality of low voltage power transfer channels and a plurality of signal channels.

At least one switching structure may be configured to be in power and/or signal exchanging relation with at least two transfer channels, and to be in power and/or signal exchanging relation with:
at least one other of the plurality of transfer channels;
at least one modular lighting structure, at least one LED array associated with a corresponding lighting module or the modular lighting structure, or at least one lighting accessory to be associated with one of the one or more lighting modules;
the adjacent supply structure;
a driver structure; and
another structure associated with the modular lighting segment structure.

The modular lighting segment structure may further comprise at least one switching structure configured to be in signal exchanging relation with at least two transfer channels, and the driver structure, to deliver signals thereto, according to a corresponding transfer channel according to an operational position of the switch structure.

In an aspect, there is provided a modular lighting segment structure assembly for use in one or more lighting modules, to deliver power and/or signals thereto, when operable in a corresponding one or more mounting sectors in a grid lighting system, the modular lighting segment structure assembly comprising:
at least one transfer structure having a plurality of transfer channels extending in a zone between at least two end regions thereof and to transfer power and/or signals along at least part of the zone;
at least one modular junction structure configured to be in power and/or signal transferring relation with corresponding ones of the plurality of transfer channels, and configured to be in direct or indirect line voltage power and/or signal transferring relation with at least one of:
   a modular junction structure on an adjacent modular lighting segment structure assembly, and
   a line voltage power and/or signal supply structure associated with the grid lighting system;
at least one modular sub-junction structure configured to be in line voltage power transferring relation, low voltage power transferring relation and/or signal transferring relation with the at least one of the plurality of transfer channels, and/or directly or indirectly with the at least one modular junction structure or the one or more lighting modules.

The at least one modular junction structure may include at least two modular junction structures, each configured to be accessible adjacent a respective end region of the at least one transfer structure.

The plurality of transfer channels may include a first group of transfer channels configured to be in line voltage power transferring relation directly or indirectly with one of the at least one modular junction structure.

The plurality of transfer channels may include a second group of transfer channels configured to be in low voltage power transferring relation directly or indirectly with at least one of the at least one modular junction structure, the least one modular sub-junction structure and the one or more lighting modules.

The plurality of transfer channels may include a third group of transfer channels configured to be in signal transferring relation directly or indirectly with at least one of the at least one modular junction structure, the least one modular sub-junction structure and the one or more lighting modules.

The plurality of transfer channels may include a first group of transfer channels configured to be in line voltage power transferring relation directly or indirectly with the at least one modular junction structure; a second group of transfer channels configured to be in low voltage power transferring relation directly or indirectly with at least one of the at least one modular junction structure, the least one modular sub-junction structure and the one or more lighting modules; and a third group of transfer channels configured to be in signal transferring relation directly or indirectly with at least one of the at least one modular junction structure, the least one modular sub-junction structure and the one or more lighting modules.

At least one transfer channel of the plurality of transfer channels may be a member of one or more of the first, second and third groups.

The modular lighting segment structure may further comprise at least one switching structure configured to be in signal exchanging relation with at least two transfer channels, and the driver structure, to deliver signals thereto, according to a corresponding transfer channel according to an operational position of the switch structure.

In an aspect, there is provided a modular lighting segment structure assembly for use in one or more lighting modules, to deliver power and/or signals thereto, when operable in a corresponding one or more mounting sectors in a grid lighting system, the modular lighting segment structure assembly comprising:
at least one transfer structure having a plurality of transfer channels extending in a zone between at least two end regions thereof and to transfer power and/or signals along at least part of the zone;
at least one modular junction structure configured to be in power and/or signal transferring relation with corresponding ones of the plurality of transfer channels, and configured to be in direct or indirect line voltage power and/or signal transferring relation with at least one of:
   a modular junction structure on an adjacent modular lighting segment structure assembly, and
   a line voltage power and/or signal supply structure associated with the grid lighting system;
at least one modular sub-junction structure configured to be in line voltage power transferring relation, low voltage power transferring relation and/or signal transferring relation with the at least one of the plurality of transfer channels, and/or directly or indirectly with the at least one modular junction structure, and at least one output structure for delivery of the line voltage power transferring relation, low voltage power transferring relation and/or signal thereto.

In an aspect, there is provided a lighting module, an LED assembly, a track lighting module, a non-track lighting module comprising one or more modular lighting segment structure as defined herein.

### BRIEF DESCRIPTION OF THE FIGURES

Several example embodiments of the present disclosure will be provided, by way of examples only, with reference to the appended drawings, wherein:

FIG. 1 is a schematic view of a prior art grid lighting system;

FIGS. 2, 3 and 4 are schematic fragmentary perspective views of a grid lighting system according to the present disclosure;

FIGS. 5, 6 and 7 are schematic sectional views of luminaire structures and/or portions thereof for use in the grid lighting system of FIGS. 2, 3 and 4;

FIGS. 8 and 9 are part-sectional assembly views of a non-track lighting module and a track lighting module, respectively, in the grid lighting system of FIGS. 2, 3 and 4;

FIG. 10 is a perspective view of a grid lighting system network;

FIGS. 11 and 12 are part-assembly views of the grid lighting system network of FIG. 10;

FIGS. 13 and 14 are schematic views of non-track and track lighting modules in the grid lighting system network of FIGS. 10 and 11;

FIGS. 15 and 16 are perspective views of a track lighting module and a housing structure segment;

FIG. 17 is an end view taken on arrow 17 in FIG. 15;

FIG. 18 is a sectional view taken on line 18-18 in FIG. 16;

FIGS. 19 and 20 are perspective views of a non-track lighting module and a housing structure segment;

FIGS. 21 and 22 are perspective views of the non-track lighting module of FIGS. 19 and 20;

FIGS. 23 to 34 show views of further other grid lighting systems according to the present disclosure;

FIGS. 35 and 36 are upward and downward fragmentary perspective views, respectively, of a pair of modular lighting segment structures, in an operative configuration;

FIG. 37 is a magnified fragmentary perspective view of a portion of one of the modular lighting segment structures of FIG. 36.

FIG. 38 is an partial assembly view of the modular lighting segment structures in respective pairs of lighting modules, while FIG. 39 is a sectional view according to the near end section as seen in FIG. 38;

FIGS. 40A, 40B and 40C are schematic view three different example configurations, of deployments of modular lighting segment structures;

FIGS. 41 to 45 are schematic views of five example operational configurations of modular lighting segment structures in relation to FIGS. 40A, 40B and 40C; and

FIGS. 46 to 48 are downward, downward and upward fragmentary perspective views, respectively, of another modular lighting segment structure in an operable configuration.

### DETAILED DESCRIPTION

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical, mechanical or other connections or couplings. The terms upper, lower, and vertical are intended for operative context only and are not necessarily intended to limit the invention only to those configurations or orientations. In any instance in which the disclosure refers to a single instance of an element, example embodiments may include a multiple of such elements. The term “at least one” in reference to any element is not intended to force an interpretation on any other reference elsewhere in the disclosure to a single instance of an element to mean only one such instance of the element. Furthermore, and as described in subsequent paragraphs, the specific mechanical and/or other configurations illustrated in the drawings are intended to exemplify embodiments of the invention. However, other alternative mechanical and/or other configurations are possible which are considered to be within the teachings of the instant disclosure. Furthermore, the present disclosure provides basis for and encompasses support for any one element, feature, structure, function, of any aspect and/or example embodiment described in the present disclosure including the figures, clauses and/or claims herein, which is itself claimed on its own or combined with any one or more elements, features, structures, functions, and/or steps from the same or any other aspects and/or example embodiments described in the present disclosure including the figures, clauses and/and claims herein.

The terms “line voltage” and “line voltage power” used herein may include, but not limited to, the voltage (and power) that a power line delivers to its destination, or the point where it is being used, such as from about 120V to about 277V at 60 W, or from about 2500 W at 277V to about 1080 W at 120V, or other such voltage levels and/or power levels appearing in power distribution systems in building structures.

The terms “low voltage”, “low voltage power” and “low power” used herein may include, but not limited to, the voltage (and power) such as specified in Class 2 UL (formerly known as Underwriters Laboratory) that is rated for electrical appliances such as lighting units, such as 48V at 60 W maximum, or other such voltage and power levels specified in residential and commercial building codes.

The term “configured installation” used herein in the context of a grid lighting network or system may include, but not limited to, an installation which is configured according to an appropriate building or energy code, including one or more instances of a specified length of a lighting (or power delivery) zone and a specified number of interchangeable line voltage lighting modules deployable therein, in order to approach, but not exceed, a maximum power delivery rating of a designated line voltage outlet (such as a circuit breaker) to power the lighting (or power delivery) zone, to enable any one of the interchangeable line voltage lighting modules to be moved from one designated location to another along the specified length of the lighting (or power delivery) zone, and still comply with the maximum power delivery rating of the designated line voltage outlet.

The terms “grid lighting system”, “grid lighting network”, “grid area”, “grid segment”, “grid configuration”, and other terms using the adjective “grid” herein may include, but not limited to, single or multiple configurations of a track, housing or other support structure, in any one or more of such configurations as T-, L-, U-, square-shaped or other configurations or combinations thereof, such as a number of x and y lengths found at one or more hubs, intersecting two or more tracks, housings or other support structures. The grid segments may be in the form of standardized or non-standard grid segments.

While the drawings show and the description describes the “grid” components generally defining a 2-dimensional configuration, it is to be understood this is done merely for convenience in the drawings and description. It is to be understood by one possessing the teachings of this specification, drawings, and claims as set forth herein, as may be amended during the prosecution, that the “grid” may extend into a third dimension and incorporate components not limited to a 2-dimensional configuration.

The term “LED” used herein may include, but not be limited to, semiconductor, electroluminescent, organic, polymeric or other material based light sources commonly known as generally as light emitting diodes, as well as polymeric and other such light sources, equivalents and variants thereof.

The term “track lighting module” used herein may include, but not limited to, an interchangeable lighting device which provides a track or other elongate supportive structure for supporting an array of one or more interchangeable lighting submodules, for example with one or more arrays of LEDs, i.e. those which are configured to electrically couple with the track or other elongate support.

The term “non-track lighting module may include, but not limited to, an interchangeable lighting device which does not provide a track or other elongate supportive structure for supporting an array of one or more interchangeable lighting submodules, for example with one or more arrays of LEDs.

The term “modular” as it relates to a modular lighting segment structure for use in assembling in a series of at least two thereof for a grid lighting network or system and/or one or more modular junction structures and modular structures used in connection therewith. The term modular may include, but not be limited to constructions with standardized, compatible, and/or complementary dimensions and/or connectivity, enabling the associated segments, structures and the like to be capable to being used in different configurations. For example such configurations may be achieved by the use of standardized, compatible, and/or complementary connectors sets, or connectors capable of being joined with adjacent complementary connectors for the purposes of assembling such grid lighting network or system.

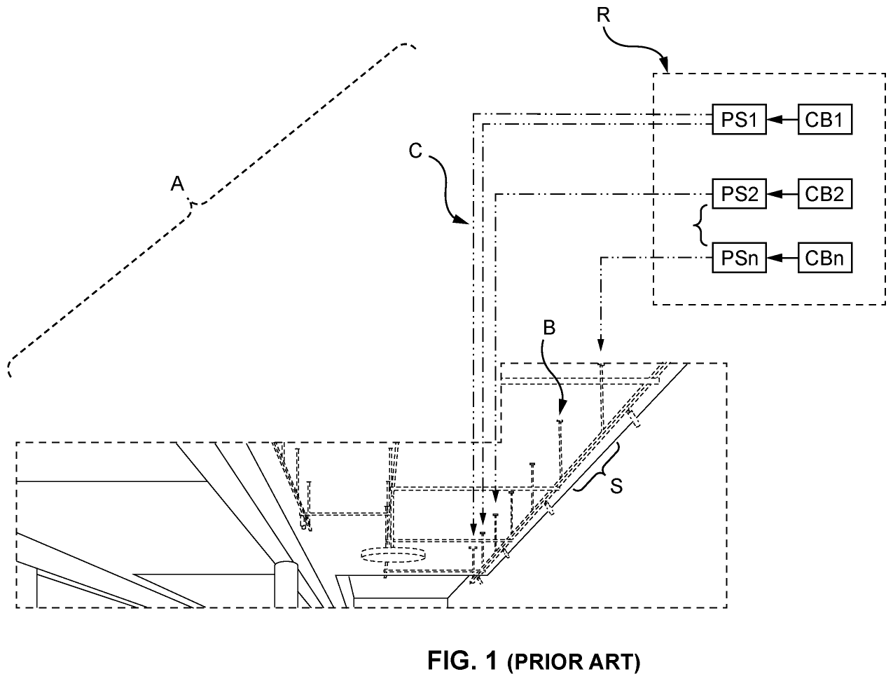

FIG. 1 shows a prior art version of a grid lighting system A, having a number of “low voltage” line drops B, which are normally provided at a designated distance, such as 8 feet, along each span S in a designated grid area. Each of the line drops B is coupled to a dedicated “low voltage” supply line C, which is powered by a power supply PS, which in turn is coupled to a designated “line voltage” circuit breaker CB. In this case, a power supply PS is required for one or several “low voltage” line drops B, and power supply PS1 is shown to supply power to two such “low voltage” supply lines C. Further, the group of power supplies PS is usually provided in a remote utility room location R housing the circuit breakers CB. This can sometimes require a considerable length of “low voltage” supply line extending between each power supply PS and the at least one corresponding line drop B. For instance, in a grid lighting system with 50 such “low voltage” line drops, there would be a corresponding requirement for power supplies PS1 to PSn, where n=50 or a subset thereof, with the consequent requirement of 50 lengths of low voltage power supply line between the power supplies PS and a corresponding “low voltage” line drop. (The thickened arrows between each circuit breaker CB and the adjacent power supply PS in FIG. 1 denotes “line voltage”, in this case between each circuit breaker CB and the corresponding power supply PS.)

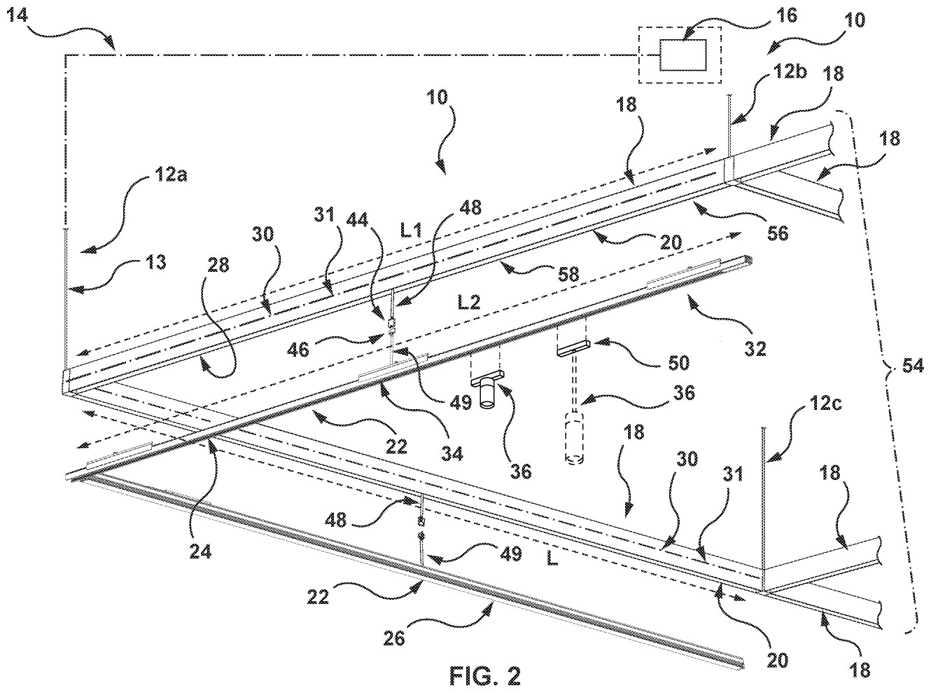

FIG. 2 shows an example embodiment in the form of a grid lighting system 10, with a single “line voltage” line drop 12a which, in this case, is held in at least one stem structure as shown at 13. Thus, while there may be a number of stem structures 13 supporting the grid lighting system 10, only one is shown to include a line drop 12, in this example, and thus to supply all the spans in a designated grid area. The single “line voltage” line drop 12a is coupled to a single “line voltage” supply line 14, which is drawn in a thickened chain-dotted line to denote “line voltage” (in contrast to the “low voltage” supply line C (shown as chain-double-dotted) in FIG. 1). The line voltage supply line 14 is in turn directly coupled to a single designated circuit breaker 16. As will be described, the line voltage supply line 14 is able to service an entire designated grid area, as will be described. Other example embodiments may involve multiple such grid areas in a corresponding multiple of configured installations for a correspondingly larger target space to be illuminated, with each supplied by a single line voltage line drop. Nonetheless, example embodiments as disclosed may provide a substantial increase in efficiency and a reduction in assembly costs, at scale.

Referring to FIGS. 2, 3 and 4, the grid lighting system 10 comprises at least one elongate support structure, which may be in the form of a housing segment, in this example embodiment showing six such housing segments 18, each with a lighting zone 20. In this case, line drops 12b and 12c do not include or provide a line voltage supply line 14.

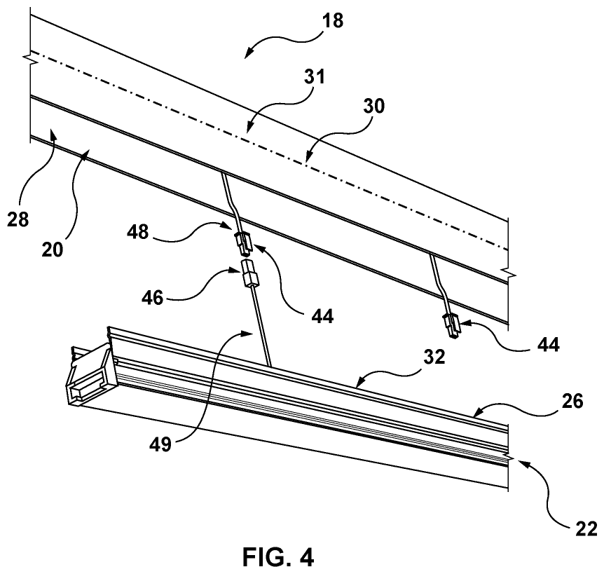

Also provided is at least one lighting module 22, which may be selected from at least one track lighting module 24 and/or at least one non-track lighting module, shown schematically at 26. Referring to FIGS. 2, 3 and 4, the lighting zone 20 of each housing segment 18 is configured to extend along a first length dimension L1 of the corresponding housing segment 18, and includes at least one first passage 28 (FIG. 4) extending at least part way along the lighting zone 20, to receive the at least one lighting module 22 therein. Each housing segment 18 includes a first power supply segment 30, which is in communication with line voltage supply line 14, to deliver line voltage power to the at least one lighting module 22 in the lighting zone 20. In this case, the first power supply segment 30 includes a first power supply cable harness, a portion of which is shown schematically at 31 (as will be further described below) extending along the housing 18. In other example embodiments, the elongate support structure may be provided as a rigid, or flexible support structure, such as a frame structure, without necessarily having a housing segment, and which may receive a lighting module thereon.

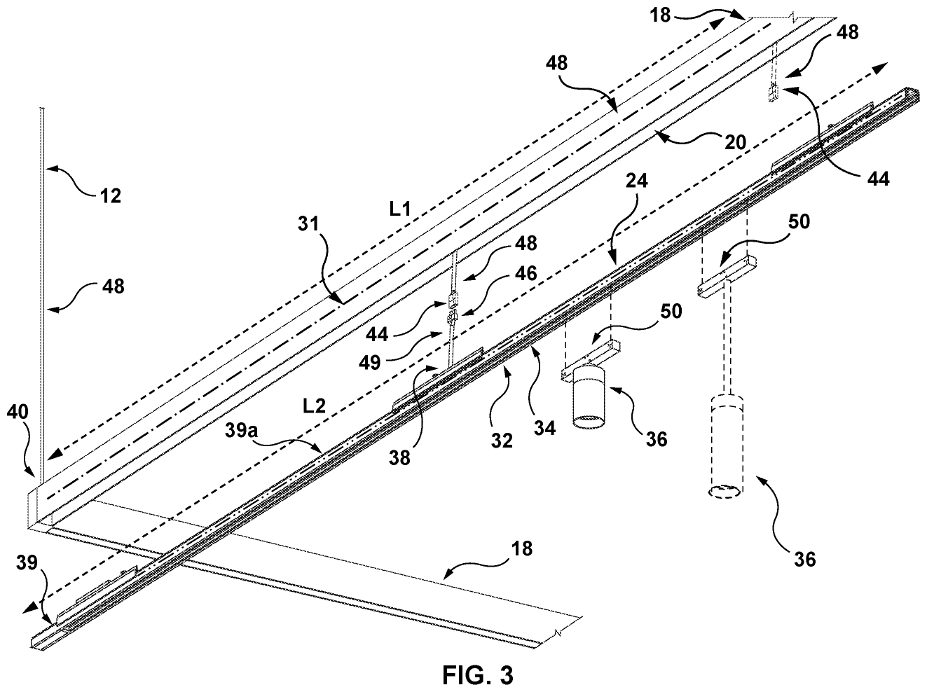

Referring to FIG. 3, each track lighting module 24 may include a lighting subzone 32 extending along a second length dimension L2 thereof. In this case, the second length dimension L2 is aligned with the first length dimension L1. In other example embodiments, the second length dimension L2 may be positioned relative to the first length dimension L1 at a non-aligned angle such as, for example, an included angle of less than 90 degrees, or less than 180 degrees.

The lighting subzone 32 may include a second passage 34 extending at least part way along the lighting subzone 32 to receive at least one lighting submodule, in this case with two such submodules shown at 36. Referring to FIG. 3, a second power supply segment 38 is configured to couple with the first power supply cable harness 31 to receive line voltage power therefrom and to deliver low voltage to the lighting submodules 36. In this case, the second power supply segment 38 includes a power supply 39 and a second power supply cable harness 39a (denoted by the chain double-dotted line) extending along the second length dimension L2 of the lighting subzone 32 to deliver lower voltage power to each of the lighting submodules 36.

Referring to FIG. 2, the first power supply cable harness 31 is thus configured in a first mode to deliver line voltage power to the at least one lighting module 22, and in a second mode (FIG. 3) to cooperate with the second power supply segment 38 in the at least one track lighting module 24 to deliver line voltage power to the second power supply 39, which in turn is configured to deliver low voltage to the at least one lighting submodule 36 via the second power supply cable harness 39a.

Referring to FIG. 3, also provided is at least one hub segment 40 to join with at least two of the housing segments 18 to form a designated grid configuration. As shown in FIG. 3, the hub segment 40 may also be coupled with the line drop 12 which may include a support cable, or a stem structure with a ½″ (or other) diameter stem structure, as an example. Examples of the hub segment 40 and housing segments 18 may be found in co-pending U.S. patent application Ser. No. 16/795,153, filed Feb. 19, 2020 and entitled COUPLERS FOR LIGHT FIXTURES, related U.S. patent application Ser. No. 15/299,168, filed Oct. 20, 2016, now granted as U.S. Pat. No. 10,215,380, and related U.S. patent application Ser. No. 16/256,356, filed Jan. 24, 2019, now granted as U.S. Pat. No. 10,584,857, the entire subject matter of both of which is incorporated herein by reference.

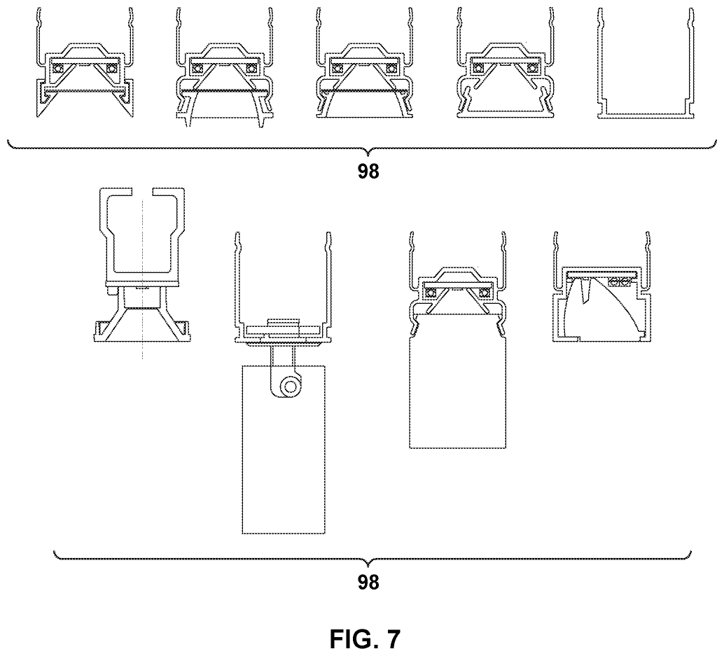

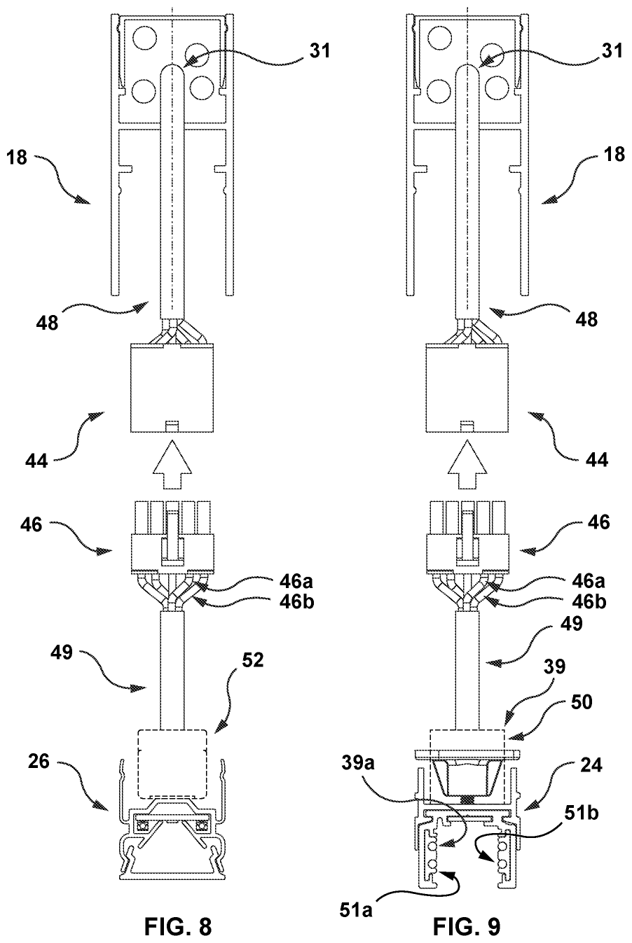

Referring to FIGS. 2, 3, 4, 8 and 9, in some example embodiments, the first power supply cable harness 31 may include a power line extending along the housing with each of a plurality of line voltage outlet plugs (or wire in terminals) 44 (FIG. 3) located on a corresponding cable 48, which may be joined to the supply line 14 and spaced along the first length dimension L1, for connection to a complementary line voltage inlet plug (or wire in terminal) 46 located on a corresponding cable 49. The cable 49 may extend from the track lighting module 24 (as shown in FIGS. 3 and 9) to be an input to the second power supply 39, or to extend from the non-track lighting module 26 (as shown in FIGS. 4 and 8). Thus, with reference to FIG. 3, a group of line voltage outlet plugs 44 may each be mounted on a corresponding cable 48 (not shown) to engage a matching line voltage inlet plug 46 on a corresponding cable 49 in the corresponding track lighting module 24, or non-track lighting module 26. The number of line voltage outlet plugs 44 can thus be configured as part of a kit, as will be described.

Referring to FIGS. 3 and 9, in some example embodiments, each of the one or more lighting submodules 36 may be configured to include a class 2 driver 50, while the second power supply 39 may thus be configured to deliver substantially constant voltage thereto, while the driver 50 may be configured to adjust the illumination of the lighting submodule 36 by stepping down the voltage delivered thereto. As shown in FIG. 9, the second supply cable harness 39a may include a number of conductive paths provided by exposed cables extending along opposite boundaries of the subzone. For example, the exposed cables 51a may be configured to present substantially constant voltage along the second passage 39, while exposed cables 51b may be configured as a part of a wired communications network channel to deliver commands to set the power level of the driver 50, as will be described. The wired communications network channel may thus originate from a corresponding number of strands 46a, 46b of cable 49 coupled to the inlet plug 46, or wired communications channel separate therefrom.

Referring to FIGS. 4 and 8, in some example embodiments, each of the non-track lighting modules 26 may include a constant current driver 52, and the first power supply cable harness 31 may be configured to deliver line voltage power thereto. Similarly, the constant current driver 52 may be controlled by way of a wired communications network channel originating from a corresponding number of strands 46a, 46b of cable 49 coupled to the inlet plug 46, or another wired or wireless communications channel separate therefrom.

Referring to FIGS. 2 and 4, some example embodiments may be provided in the form of a kit for assembling a grid lighting network or grid network shown in part at 54. The kit may comprise a first plurality of housing (or grid) segments 18 configured to be assembled to form the grid network 54, by way of a plurality of hub segments 40, to define a second plurality of mounting sectors 56 in lighting zone 20 for supporting each of a third plurality of lighting modules 22, which in the case of grid lighting system 10 may be defined along the first passage 28. In the case of FIG. 2, each of the track lighting module 24 and/or the non-track lighting module 26 may have a second length dimension L2 equal to or approximating the first length dimension L1 of the corresponding housing segment 18, which may mean that each housing segment 18 may have one such mounting sector 56. In other example embodiments, where the track lighting modules 24 and/or the non-track lighting modules 26 may have a shorter length than the corresponding housing segment 18, the latter may provide more such mounting sectors 56 as the case may be. In still other example embodiments, the dimensions of the mounting sectors 56 may not be particularly relevant in respect of the dimensions of a corresponding track or non-track lighting module, for example if the latter is a pendant.

The kit may also comprise at least one first power supply segment 30 (such as in the form of the first power supply cabling harness 31) to be coupled to a first line voltage outlet, such as the circuit breaker 16, to deliver line voltage power to each of the mounting sectors 56 in at least one first power delivery zone 58 in the grid lighting network 54. The first power supply cabling harness 31 may be formed by individual segments installed in each corresponding housing segment 18, and configured to be in communication with one another throughout the mounting sector 56 of the grid lighting network 54 to be supplied by the supply line 14, by way of electrical connections made between such individual housing segments 18 at each corresponding hub segment 40. In other example embodiments, the first power supply cabling harness 31 may be installed in the corresponding mounting sector 56 of the grid lighting network 54 once assembled.

The first power delivery zone 20 may thus be defined by:
i. a designated number of the mounting sectors 56; and
ii. a designated number of the lighting modules 22, each configured for mounting in the first power delivery zone 58 at one of the designated number of mounting sectors 56.

In some example embodiments, the first power delivery zone 58 may also be defined by a designated number of the grid segments 18.

The first power delivery zone 58 may be configured according to a first combined lighting unit power rating for the first power delivery zone 58 to approach but not exceed a maximum power delivery rating of the first line voltage outlet, such as the current breaker 16, to enable any one of the designated number of mounting lighting modules 22 to be moved from one of the mounting sectors 56 to another mounting sector 56 in the designated number thereof, and still comply with the maximum power delivery rating of the first line voltage outlet.

Thus, in some example embodiments, a single delivery zone 58 powered by the circuit breaker 16, may be configured to approach but not exceed a maximum power delivery rating of a first line voltage outlet, such as the current breaker 16. In other example embodiments, a plurality of delivery zones 58 may be powered by the circuit breaker 16, in which case the plurality of power delivery zones 58 may be configured to approach but not exceed a combined maximum power delivery rating of the current breaker 16.

In some example embodiments, the designated number of lighting modules 22 may be selected from one or more track lighting modules 24 and/or one or more non-track lighting modules 26.

In some example embodiments, a method may be provided to prepare a configured installation of a grid lighting network installation in a target space, with a designated space, such as an interior space, and/or a designated purpose or function. The present method may allow for the grid lighting network installation to be reconfigured after the original installation should the primary interior space or a portion thereof, and/or designated purpose or a portion thereof change following original installation. While an interior space is referred to herein it should be understood that the present structures and functions will also perform in a substantially similarly if not in an identical manner in an exterior setting, combination of interior and exterior, or other settings.

A first step may be to provide a plurality of grid segments 18 which are each configured to be assembled into the grid lighting network 54 for supporting each of a plurality of interchangeable lighting modules 22 at a corresponding one of a plurality of mounting sectors 56 defined on the grid lighting network 54. Next, the plurality of grid segments 18 may be allocated to at least a first power delivery zone 58, defined by:
i. a corresponding designated number of mounting sectors 56 along the designated first power delivery zone 58; and
ii. a designated number of the interchangeable lighting modules 22, each for mounting at any one of the designated first number of mounting sectors 56 in the first designated power delivery zone 58.

Another step may be to provide at least one first power supply, such as first power supply segment 31, to be coupled to a first line voltage outlet, such as one or more outlet plugs 44, to deliver line voltage power to each of the number of mounting sectors 56 in the first power delivery zone 58.

Another step may be to configure the designated number of mounting sectors 56 in the first power delivery zone 58 according to a first combined lighting unit power rating for the first power delivery zone 58 to approach, but not exceed, a maximum power delivery rating of the first line voltage outlet, such as one or more outlet plugs 44. This step may thus enable any one of the designated number of lighting modules 22 to be moved from one mounting sector 56 of the designated number to another mounting sector 56 thereof, and still comply with the maximum power delivery rating of the first line voltage outlet.

Another step may be to select the designated number of interchangeable lighting modules 22 from one or more track lighting modules 24, or one or more non-track lighting modules 26.

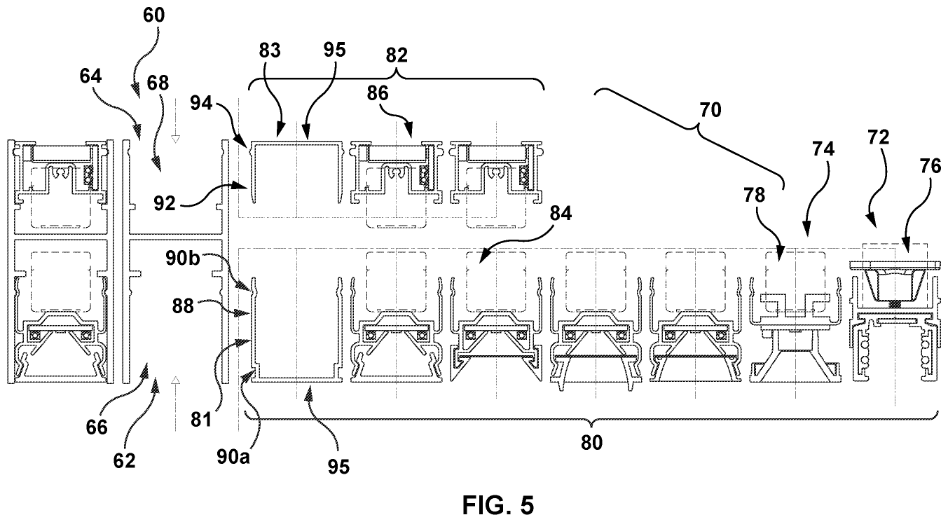

FIG. 5 shows another example embodiment of a housing segment 60 which is configured to be assembled to form the grid network 54 as discussed herein. The housing segment 60 has a direct lighting zone 62 and an oppositely oriented indirect lighting zone 64, which in this case is opposite the direct lighting zone. Each zone 62, 64 extends along a length dimension of the housing segment 60 and includes a corresponding passage 66, 68 to receive one or more lighting modules therein, such as those shown collectively at 70.

The collection of lighting modules 70 may include at least one track lighting module 72 and at least one non-track lighting module 74. In the case, the collection of lighting modules 70 includes a number of different lighting configurations among the many that may be used. Each track lighting module 72 therein, in this example, may include a constant voltage driver 76, while the non-track lighting module 74 may include a constant current driver 78.

Each of the lighting modules in the collection 70 may be further configured into, or be selected from, a direct group 80 and an indirect group 82, wherein each has a housing structure 84, 86 which may be configured to fit exclusively in its corresponding direct passage 66 or indirect passage 68 respectively. For instance, each lighting module in the direct group 80 may be provided with at least one dimension and/or formation which differs from a corresponding at least one dimension and/or formation of each lighting module in the indirect group 82.

In the case of the lighting modules in direct group 80 of FIG. 5, each may have a pair of side wall sections 88 which are longer (or shorter) in vertical section and may be provided with one or more surface formations such as recesses 90a, 90b. Meanwhile, each of the lighting modules in indirect group 82 may have a pair of sidewall sections 92 which are shorter (or longer) in vertical section and may be provided with one or more surface formations such projections 94. The indirect group 80 and direct group 82 each includes end wall sections 81 and 83 to be used in place of a corresponding lighting module in some examples. As is evident in FIG. 5, in both the direct and indirect groups, a module is provided which is configured to close the housing segment when not in use, such as by the providing of the end cap configurations shown at 95.

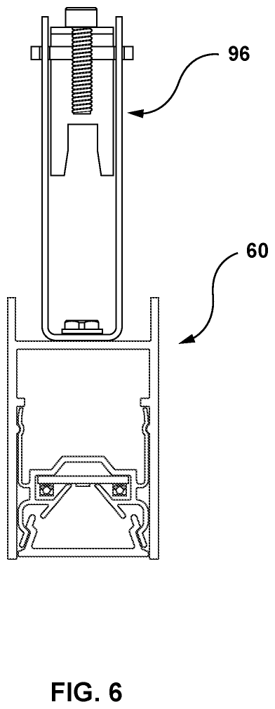

FIG. 6 shows example embodiments of a housing segment 60 secured to an anchor structure 96 such as any such structures disclosed and shown in co-pending U.S. Pat. App. Nos. 62/820,083 filed Mar. 18, 2019 and Ser. No. 16/723,665 filed Dec. 20, 2019, both entitled MOUNT INTERFACE FOR LIGHT FIXTURES, the entire subject matter of both of which is incorporated herein by reference. FIG. 7 shows example embodiments of lighting modules collectively at 98.

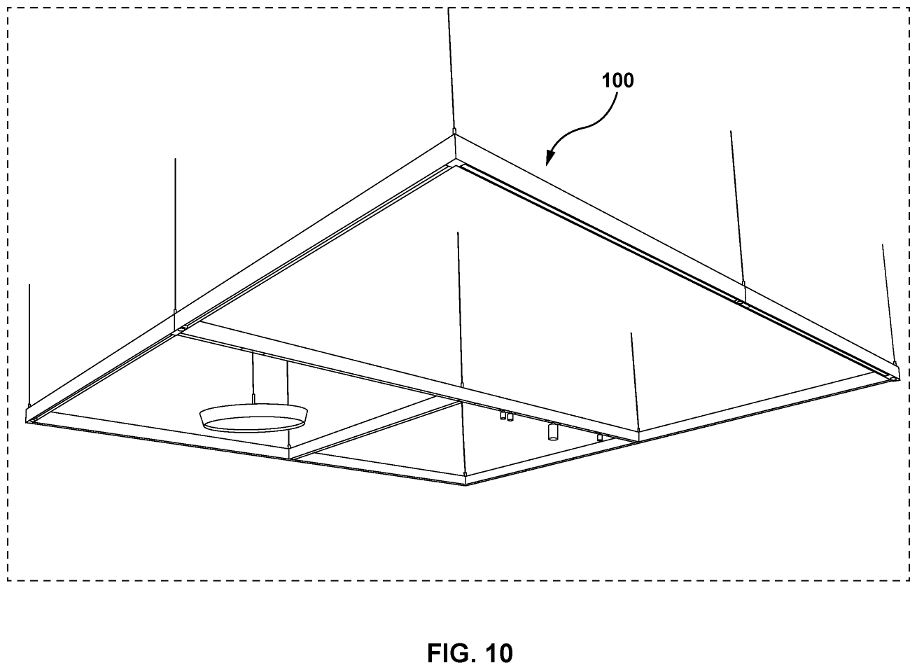

FIGS. 10 to 14 show another grid lighting network 100, having a first plurality of grid segments 102, each of which may be configured to be assembled to form the grid lighting network 100 and to define a second plurality of mounting sectors, with several such mounting sectors shown at 104. Each mounting sector 104 may be configured to operatively couple with a corresponding one of a third plurality of lighting modules 106.

At least one first power supply segment 110 may be provided which may be configured to be associated with the grid lighting network 100 and to be coupled to a first line voltage outlet as shown schematically at 112, via one of a plurality of stem structures 114, to deliver line voltage power to each of the mounting sectors 104 in at least one first power delivery zone generally shown at 118. In this case, the at least one first power delivery zone 118 may be defined by a designated first number of the second plurality of mounting sectors 104; and a designated first number of the third plurality of lighting modules 106.

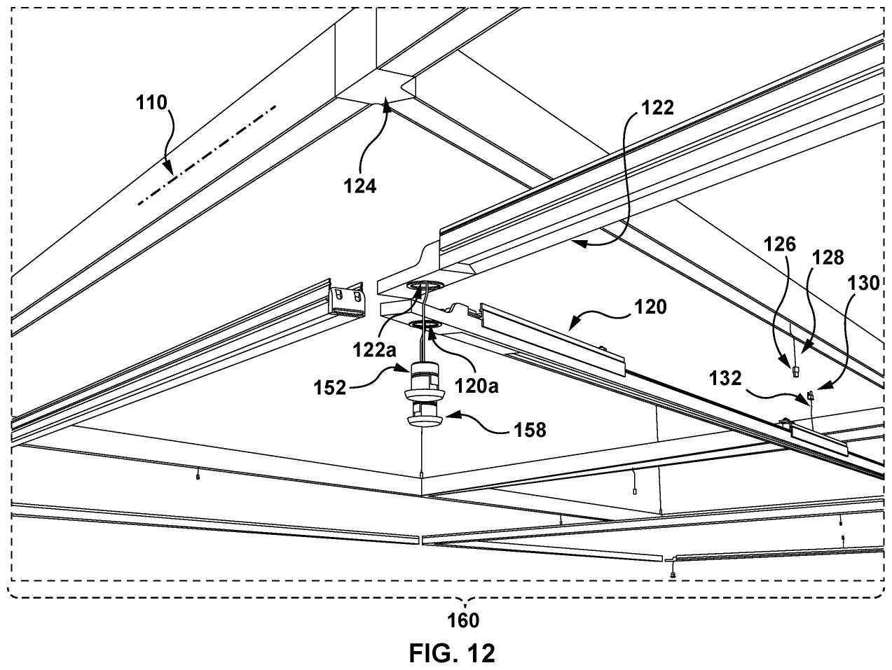

The at least one first power delivery zone 118 may be configured according to a first combined lighting unit power rating for the first power delivery zone 118 to approach, but not exceed, a maximum power delivery rating of the first line voltage outlet 112, to enable any one of the designated first number of lighting modules 106 to be moved from one of the mounting sectors 104 in the designated first number thereof to another of the mounting sectors 104 in the designated first number thereof, and still comply with the maximum power delivery rating of the first line voltage outlet 112. Referring to FIG. 12, the designated first number of lighting modules 106 may be selected from one or more track lighting modules 120 and/or one or more non-track lighting modules 122.

A plurality of hub segments 124, such as those disclosed in example embodiments in the present disclosure, may be provided to couple the first plurality of grid segments 102 together to form the grid lighting network 100. The hub segments 124 may be in the form of standardized or non-standard hub segments for interconnecting the grid segments 102.

In this case, the grid lighting network 100 may be formed from a kit which may be configured to include the first number of lighting modules 106, or be configured for the first number of lighting modules 106, or one or more thereof, to be supplied separately. The at least one first power supply segment 110 may include one or more line voltage outlet plugs 126 spaced along each mounting sector of the designated first number thereof.

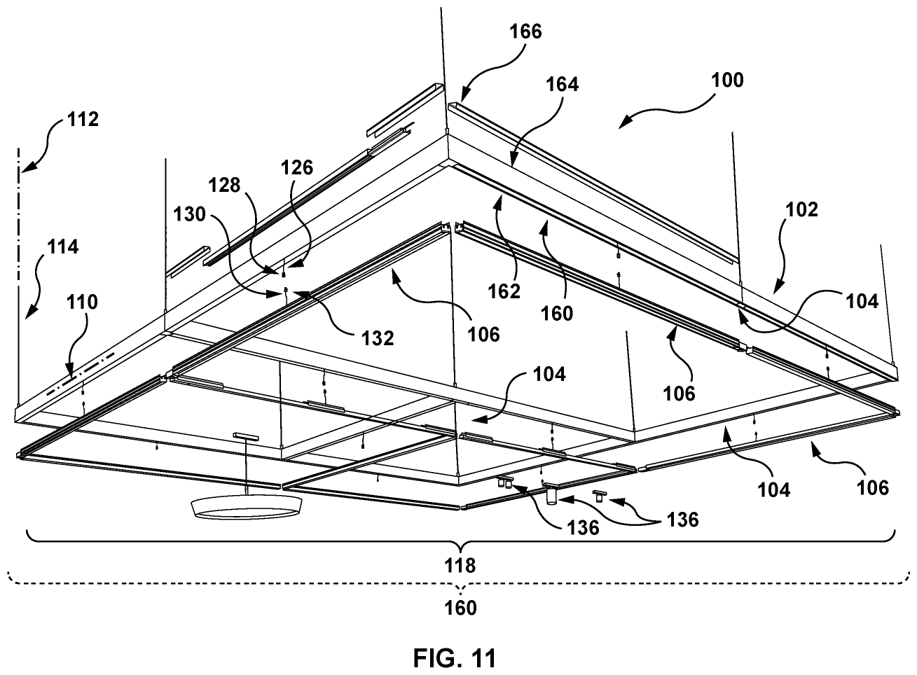

Each of a group of one or more of the line voltage outlet plugs 126 may be mounted on a corresponding cable segment 128 to engage a complementary line voltage inlet plug 130 in the corresponding lighting module 106 on a corresponding cable segment 132. In this case, each track lighting module 120 of the designated first number of lighting modules 106 may be configured to receive one or more lighting submodules 136, three of which are shown in FIG. 11.

As schematically shown in FIG. 14, each lighting submodule 136 may include one or more arrays of one or more LEDs 138, and a submodule driver 140. Each track lighting module 120 may further comprise a second power supply segment 142 configured to deliver low voltage power to each of the submodule drivers 140, in which case the submodule driver 140 may be provided as a constant current Class 2 driver.

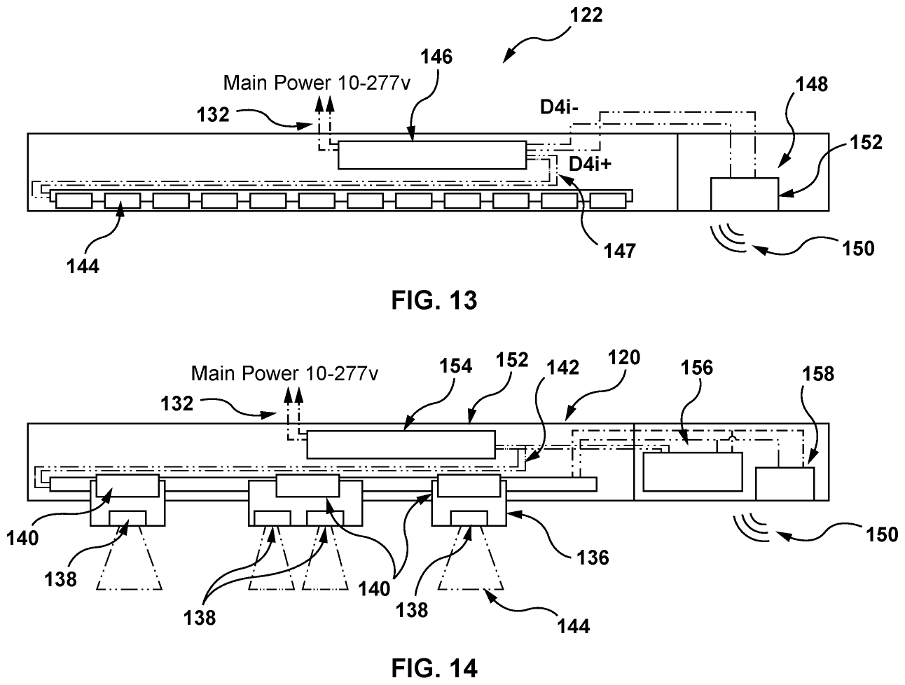

Referring to FIG. 13, each non-track lighting module 122 may include one or more arrays of one or more LEDs 144, and a Class 2 driver 146 to deliver substantially constant current to the arrays of LEDs 144, via power supply segment 147.

Each non-track lighting module 122 may further comprise a first power controller segment 148 for controlling a first power level of output power to be delivered by the driver 146 to the one or more arrays of LEDs 144. The first power controller segment 148 may be configured to be addressable in a wired and/or wireless network, such as a wireless channel shown at 150 (or a wired channel such as may be provided via the cable segment 132), to receive commands to set the first power level by way of sensor segment 152. In this case, the sensor segment 152 may be integrally provided by the first power controller segment 148. As can be seen in FIG. 12, the non-track lighting module 122 may include a passage 122a to receive the first wireless sensor segment 152. The first power controller segment may be configured to communicate with the first wireless sensor segment to exchange signals on the wireless network.

Referring to FIG. 14, the second power supply segment 142 may further comprise a second power supply 154 and a second power controller segment 156 for controlling a second power level of output power to be delivered by the second power supply 154 to the one or more lighting submodules 136. The second power controller segment 156 may be configured to be addressable in a wired and/or wireless network, including the wireless channel 150 (or a wired channel such as may be provided via the cable segment 132), to receive commands to set the second power level, by way of sensor segment 158. As can be seen in FIG. 12, the track lighting module may include a passage 120a to receive the sensor segment 158.

Thus, in some example embodiments as shown in FIG. 11, a designated first number of one or more of the first plurality of grid segments 102 may be configured to provide at least one lighting zone 160, wherein the at least one lighting zone 160 may include at least one direct lighting zone 162 and/or an oppositely oriented indirect lighting zone 164. In this case, one or more closure structures as shown at 166 may be deployed to close one or more direct or indirect lighting zones not in use one or more locations in the grid lighting network 100.

The at least one first power supply segment 110 may be configured to receive the line voltage power at a voltage of from about 120 volts to about 277 volts at 60 watts (or at another level according to the one or more configurations or attributes of the grid lighting network 100 or components thereof), while the second power supply segment 142 may be configured to deliver the low voltage at a voltage of about 12 to about 48 volts at 60 watts (or at another level according to the one or more configurations or attributes of the grid lighting network 100 or components thereof).

The at least one first power supply segment 110 may further comprise a plurality of the first power supply segments 110, with each integrated into a corresponding grid segment 102, while each of the first power supply segments 110 may be configured to be electrically coupled with one or more adjacent first power supply segments 110 in the grid network 100 at a corresponding hub segment 124.

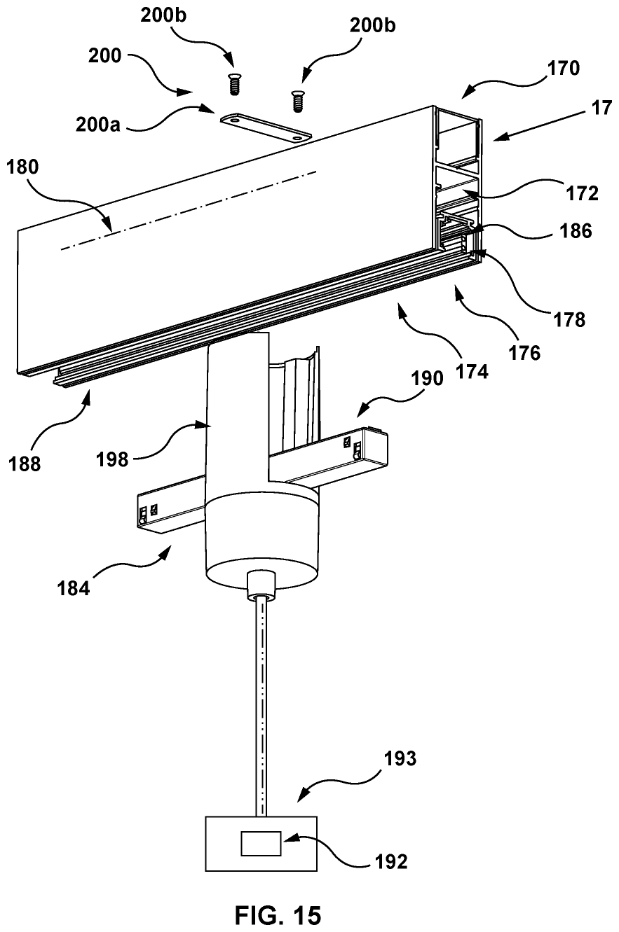

In some exemplary embodiments as shown in FIG. 15, one or more of the grid segments may include a housing structure segment 170, each which may define a first channel 174 to define at least one mounting sector 176, wherein the track lighting module 178 and/or non-track lighting module (not shown) are removably secured therein. In this case, a first power supply segment 180 may be associated with the housing structure segment 170 for delivering the line voltage power to the mounting sector 176.

The track lighting module 178 may include a second power supply segment (not shown) to receive the line voltage power and to deliver low voltage power to the at least one array of one or more LEDs, shown at 192.

In this case, the first and/or second power supply segments may be configured to be addressable in a wired and/or wireless network to receive operational commands for controlling the corresponding line voltage power to be delivered to the at least one track lighting module and/or at least one non-track lighting module, and/or the corresponding low voltage power to be delivered to the one or more arrays of one or more LEDs.

As can be seen in FIG. 15, the track lighting module 178 may be configured to be received in the first channel 174 in a configuration to receive the one or more lighting submodules 184. Each track lighting module 178 may include a track structure 186 defining a second channel 188, and each lighting submodule 184 may include a coupling structure 190 to be received by the track structure 186 in the second channel 188 in an operative position wherein the track structure 186 and the coupling structure 190 are configured to deliver the low voltage power to the lighting submodule 184.

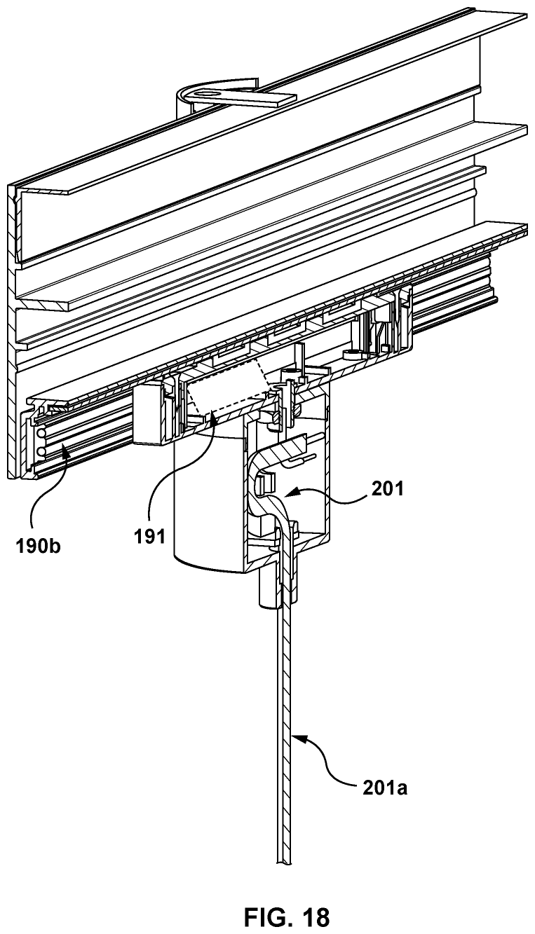

The coupling structure 190 may include a power supply segment, which may include a constant current driver or a constant voltage power supply shown schematically at 191 in FIG. 18, to deliver a second low voltage power to the at least one array 192. Examples of the track structure 186 and coupling structure 190 may, for example, be commercially available at AAGSTUUCHI, as can be seen at https://www.aagstucchi.it/en/products/track-systems/, which may provide contacts 190a configured to engage exposed cables 190b to deliver lower voltage power, and in some cases wired communications commands to the lighting submodule.

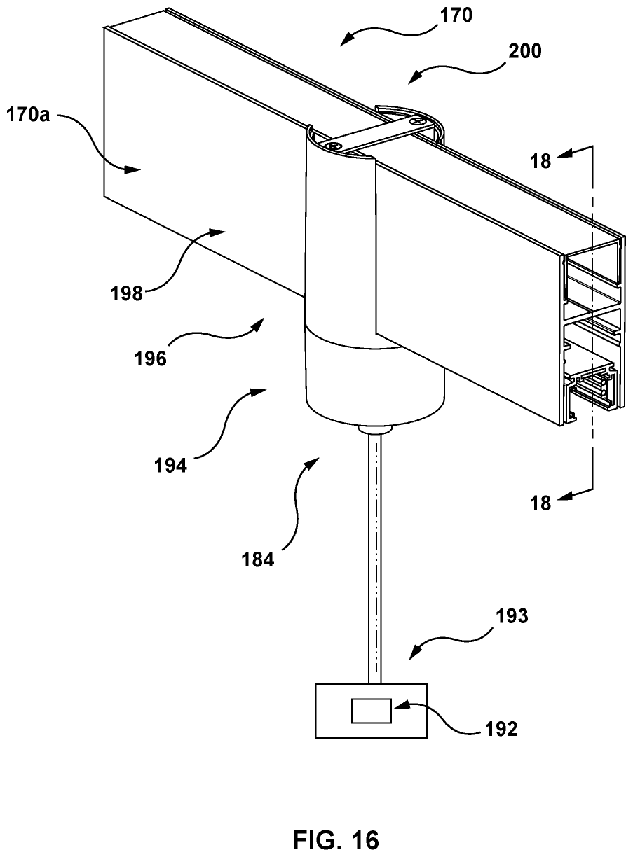

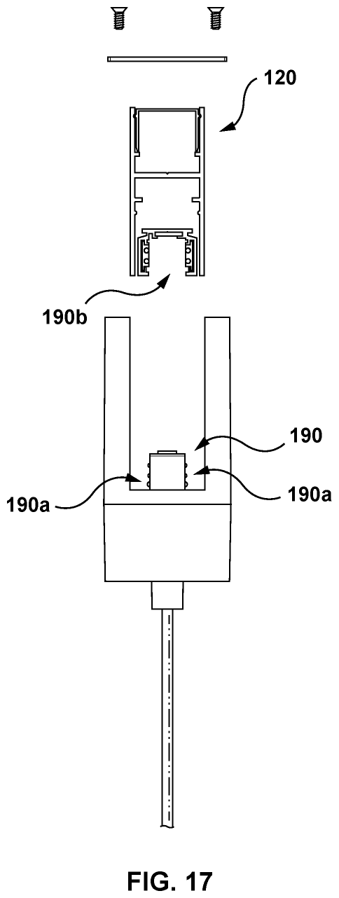

Referring to FIG. 16, the lighting submodule 184 may include bridging structure 194 to enable electrical connections between the coupling structure 190 and the at least one array 192, along with mounting structure 196 to releasably mount the lighting submodule 194 to the housing structure segment 170 with the coupling structure 190 in the operative position.

The mounting structure 196 may include at least one arm 198, configured to extend along a corresponding boundary 170a of the housing structure 170 and a retaining structure to releasably engage the arm 198 and the housing structure segment 170. In the example embodiment of FIG. 16, the mounting structure 196 may include a pair of arms 198 configured to extend along opposite boundaries 170a of the housing structure segment 170, and the retaining structure 200 may be configured to releasably engage at least one of the arms 198 and the housing structure segment 170. The retaining structure may include a retaining plate 200a removably secured to the arms 198 by way of fasteners 200b extending into correspondingly aligned passages in the retaining plate 200a and the arms 198. The bridging structure may also be associated with an anchoring structure 201 providing a cable 210a to anchor and/or support at least one pendant or non-pendant light fixture 193 supporting the at least one array 193.

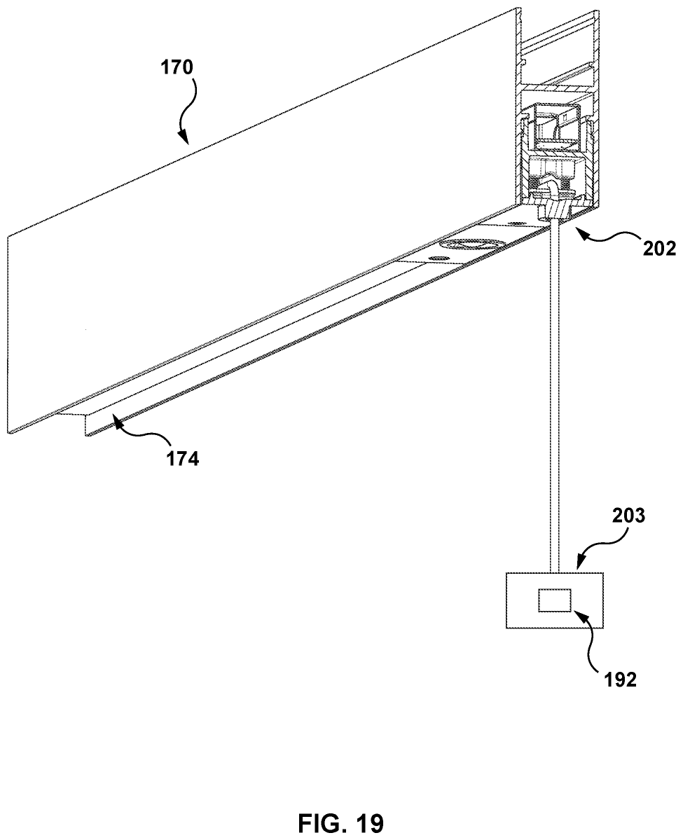

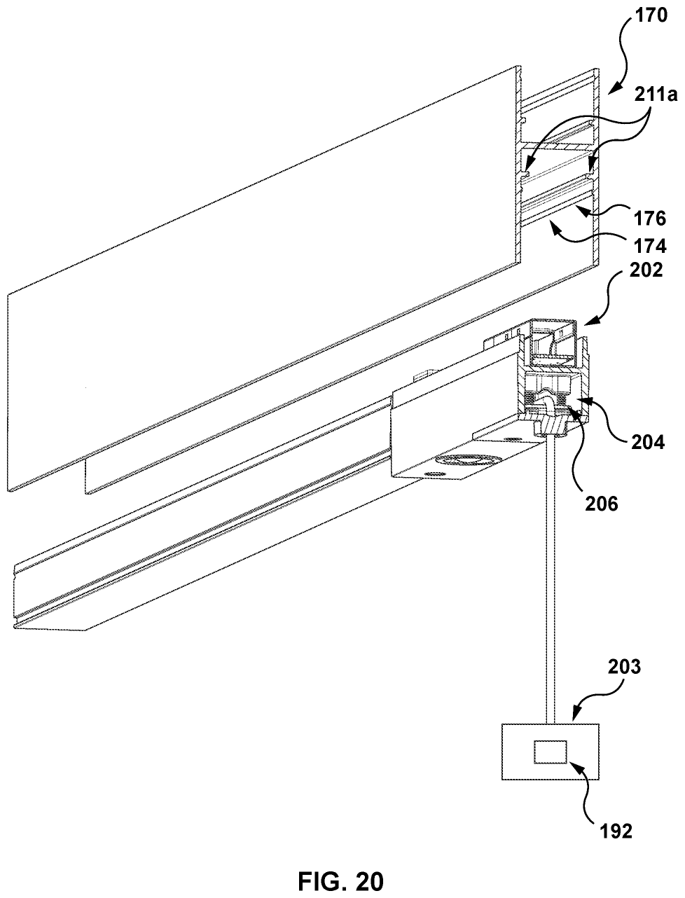

Referring to FIG. 19, the non-track lighting module 202 may be configured to be received in the first channel 174 in a configuration to anchor at least one pendant or non-pendant light fixture thereto, shown schematically at 203 containing at least one of the one or more arrays 192.

The non-track lighting module 202 may include a coupling structure 204 to be received in the first channel 174 and configured to receive the line voltage power from the mounting sector 176 and to deliver the low voltage power to the at least one pendant or non-pendant light fixture 203 thereto, containing the at least one array 192. A bridging structure 204 such as shown at 206 may enable electrical connections between the coupling structure 204 and the at least one pendant or non-pendant light fixture.

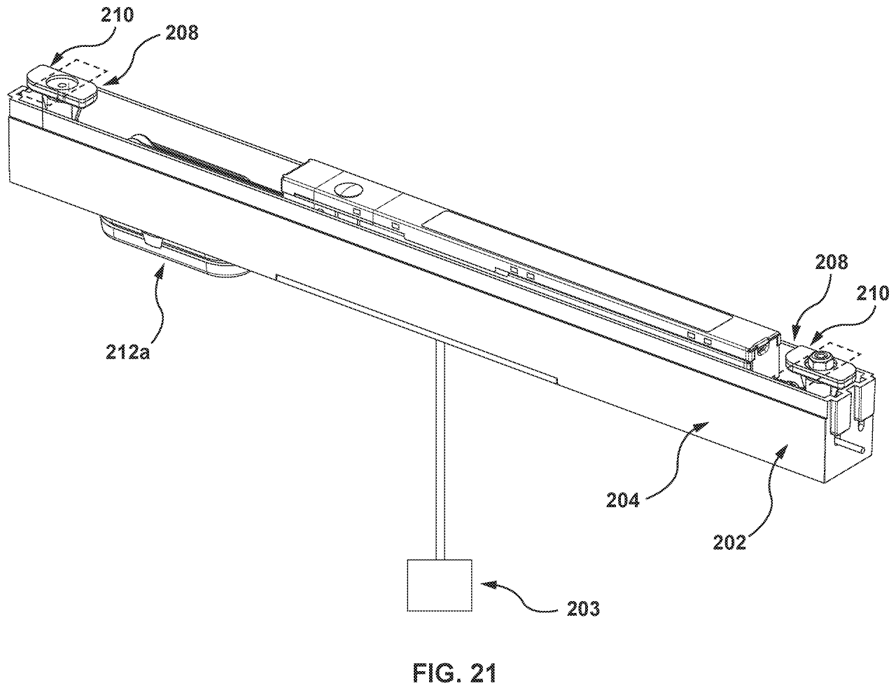

As may apply to the track lighting module 178, the non-track lighting module 202 may include one or more releasable locking structures 208 to removably lock the non-track lighting module 202 in the first channel 174. The one or more releasable locking structures 208 may include one or more latches 210 movable between a released position (shown longitudinally oriented in FIG. 21) and a locking position (in which they transversely oriented as shown in dashed lines), wherein in the locking position the one or more latches engage a complementary stop segment, in this case a pair of opposed stop segments 211, associated with the housing segment adjacent the first channel.

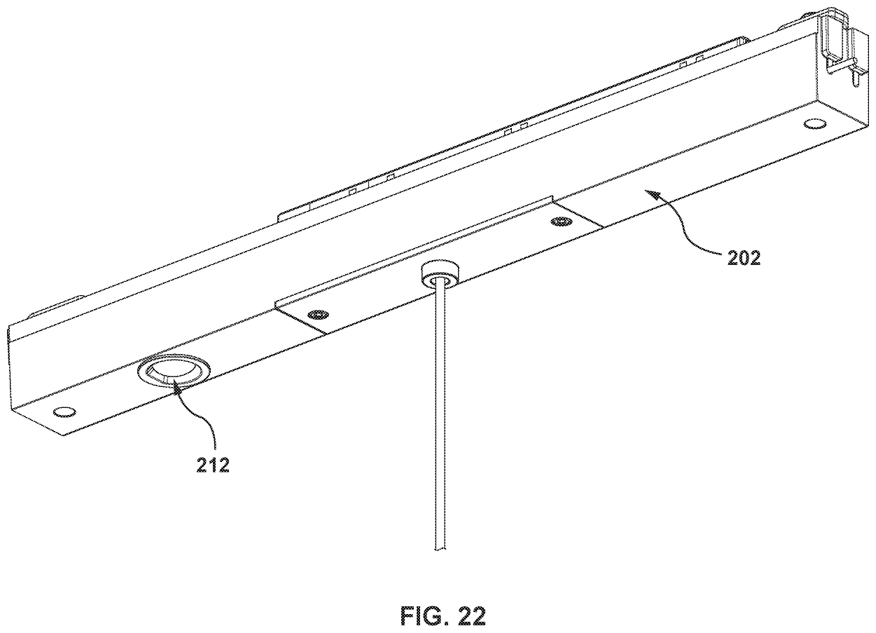

As can be seen in FIG. 22, the non-track lighting module 202 may be provided with a sensor segment 212 (and a cover 212a as seen in protective cover as shown in FIG. 21) to be addressable in a wired and/or wireless network to exchange operational messages or commands which may be associated with one or more operational or specified attributes of the non-track model 202 or other segments, structures or models in a particular portion or regions of a grid lighting network, including an identity of or designated locational datum or data for or in reference or a designated location, to one or more such non-track modules or track modules, or to receive operational commands for controlling the lower voltage power to be delivered to the one or more arrays of one or more LEDs.

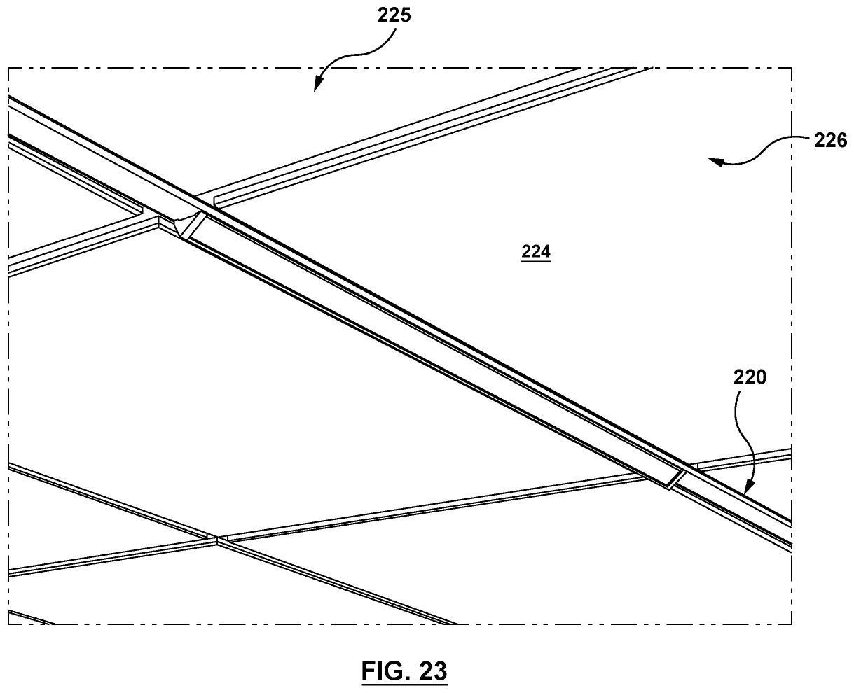

Thus, as shown in the FIGS. 2, 6 and 23, example embodiments of a grid lighting system (or network) may provide at least one housing segment which may be configured to be suspended in a first position below the ceiling structure, for example as shown in FIG. 2. Alternatively, the at least one housing segment which may be configured to be positioned in a second position adjacent a facing surface defined by the ceiling structure, for example as may be provided by the configuration of FIG. 6. Alternatively, the at least one housing segment may be configured to be positioned in other configurations, such as in a third position within the ceiling structure with the at least one lighting zone accessible adjacent the facing surface, as shown by the configuration of FIG. 23.

FIG. 23 thus shows a configuration with a housing segment 220 in the third position within a lighting zone adjacent the facing surface 224 of a grid lighting network 225 in a ceiling structure 226.

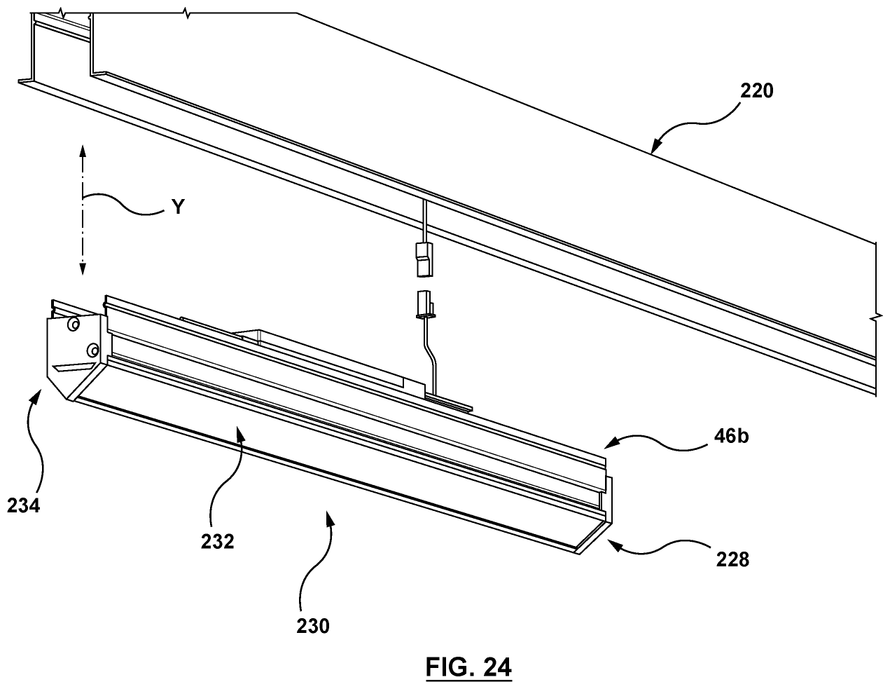

Referring to FIG. 24, an anchor structure (not shown) may be provided for securing the housing segment 220 in the third position. A lighting module 228 may include at least one light delivery structure 230 configured to be directed deliver light to a designated region in an interior space. In the example embodiment of FIG. 24, the lighting module 228 may include a pair of the light delivery structures shown at 232, 234 configured to be directed deliver light to respective designated regions in the interior space. The pair of light delivery structures 232, 234 may be configured to deliver light at opposed angles relative to a vertical axis Y, and wherein the opposed angles may be substantially equal or be unequal relative to the vertical axis Y.

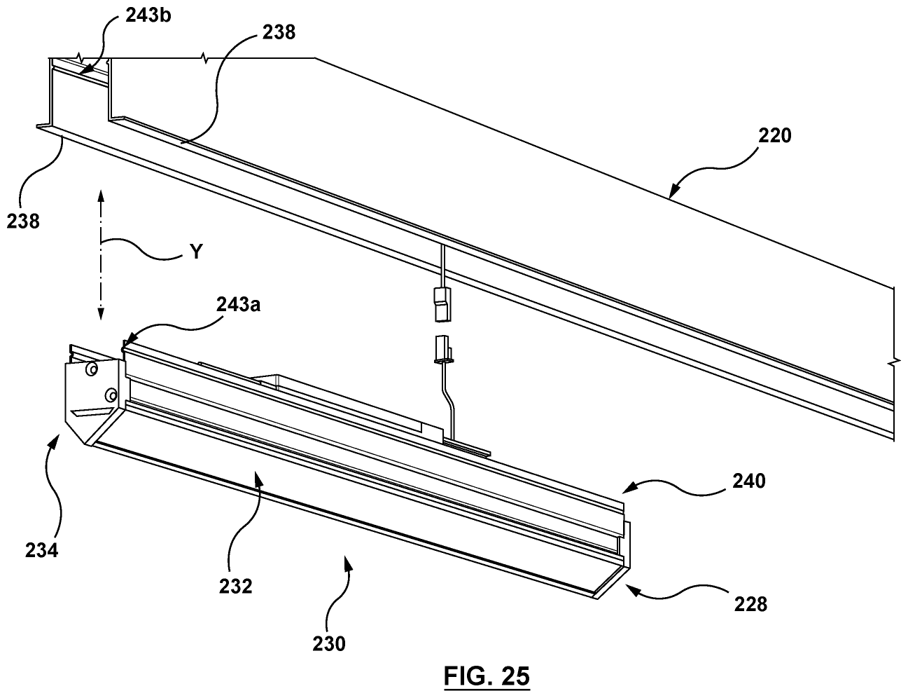

As can further be seen in the example embodiment of FIG. 25, the housing segment 220 may include a pair of opposed first locating flanges, one shown at 238, for locating adjacent corresponding boundaries of a designated opening in the facing surface 224 to receive the housing segment 220. The at least one lighting module 228 may include a pair of opposed second locating flanges, one shown at 240, each of which is configured to be located adjacent a corresponding first locating flange 238 when in an operative position in the at least one lighting zone. In this instance, the housing segment 220 and the second location flanges 240 may be provided with complementary locating structures, in the form of a projections 243a and complementary recesses 243b in either the housing segment 220 or lighting module 228.

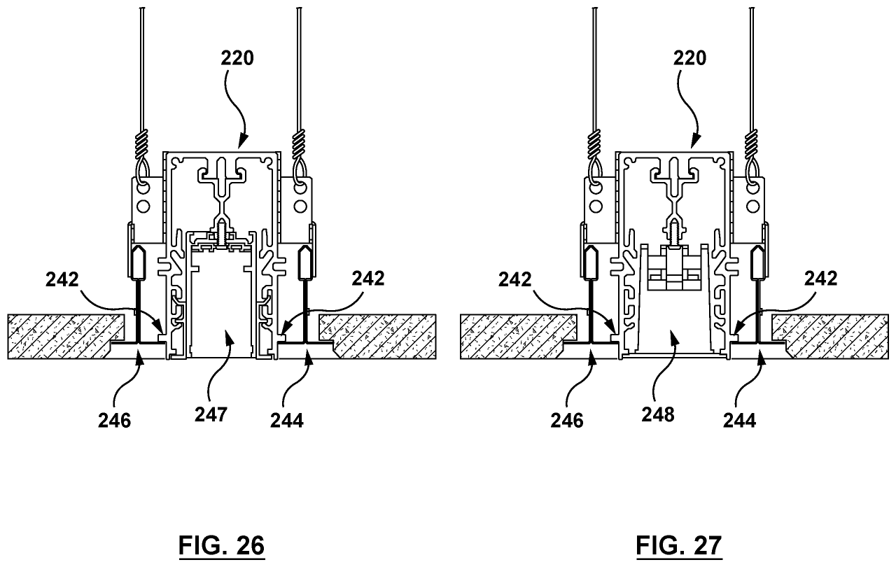

Further example embodiments are shown in FIGS. 26 and 27, in which the housing segment 220 is provided with locating flanges 242 which may be configured to engage adjacent surfaces on opposed t-bar structures 244, 246, with the housing segment 220 located therebetween. In this case, the example embodiment of FIG. 26 includes a track structure insert 247 for location inside the housing segment 220 to receive an LED array module insert (not shown), while the example embodiment of FIG. 27 includes an LED insert module 248.

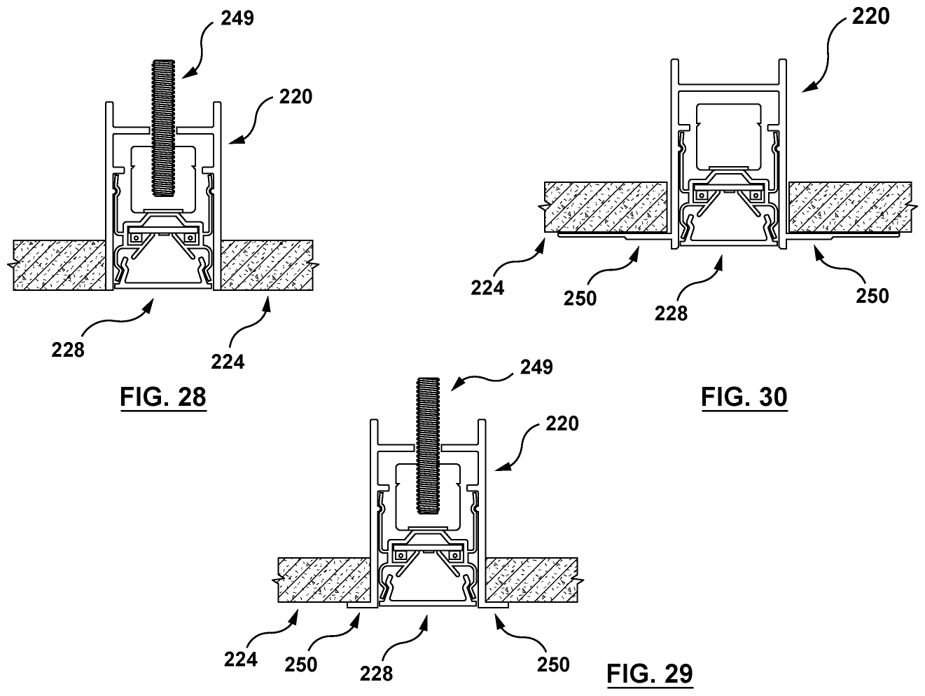

Further example embodiments are shown in FIGS. 28 to 30. As shown in FIG. 28, the housing segment 220 may be located within the ceiling structure without the provision of locating flanges, by utilizing an anchor shown at 249. As shown in FIGS. 29 and 30, combinations of an anchoring structure 249 and locating flanges 250 may be used to position the housing structure 220 in the third position, in instances where a lighting module 228 may engage with other structures within the housing segment 220 to be positioned adjacent the facing surface 224.

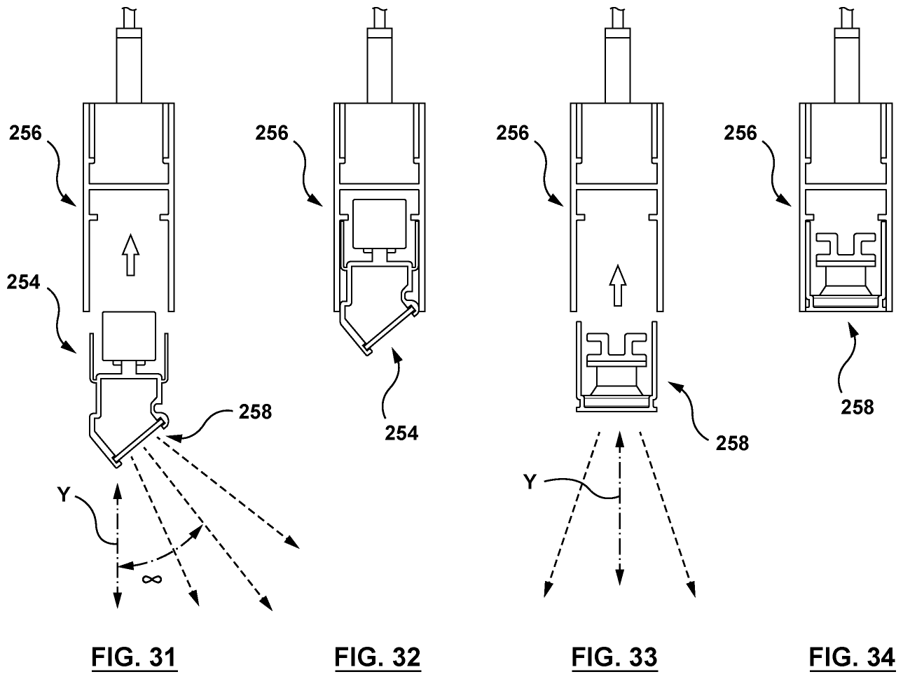

FIGS. 31 and 32 show successive views of an example embodiment in which a lighting module 254 may be provided with a light delivery structure 258 oriented at an angle co relative to axis Y. FIGS. 33 and 34 show successive views of an example embodiment in which a lighting module 254 may be provided with a light delivery structure 258 oriented generally in line with axis Y.

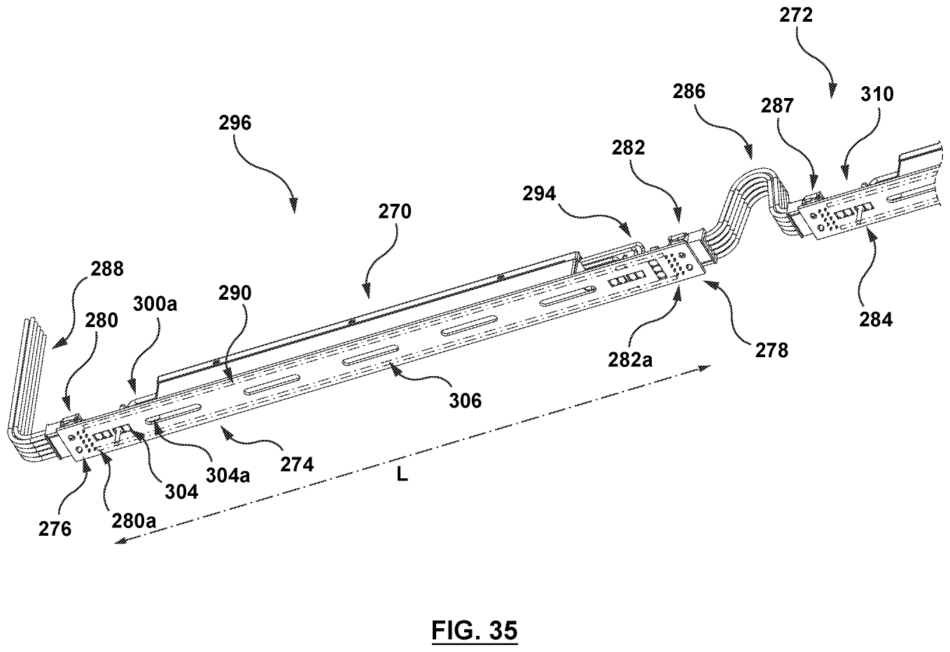

FIGS. 35 to 39 illustrate another example embodiment, in this case of a modular lighting segment structure 270 for use in assembling in a series of at least two thereof for a grid lighting network, such as the recessed grid lighting network 225 of FIG. 23. For example, in FIG. 35, the modular lighting segment structure 270 is shown to be assembled, in this instance, in a series of two with an adjacent modular lighting segment structure, a portion of which is shown at 272. In this example modular lighting segment structures 270 and 272 may be associated with housing structures to support one or more LED arrays, as part of two or more lighting structures to be installed in a grid lighting system, as joined to or associated with one another end to end, or in other configurations as desired, to form a modular assembly of a lighting structure to be located in a designated location in the grid lighting network and configured to receive line power from at least one line power supply.

In this case, the modular lighting segment structure 270 may include a power supply segment which may be provided by at least one transfer structure 274 which may be configured to provide for a transfer of line voltage power directly or indirectly from a line voltage power source (and in some cases may also provide for the transfer of low voltage power directly or indirectly from a low voltage power source), and/or signals, by way of example but not limitation, such as control and/or communication signals, along a dimension, such as a length dimension L thereof. The transfer structure 274 may have at least a pair of opposed or spaced apart end regions shown at 276 and 278, thus enabling the modular lighting segment structure 270 to convey line voltage power, low voltage power, and/or signals along the transfer structure 274, and in some example embodiments, so as to carry line voltage power, low voltage power, and/or signals along the region of the grid lighting network 225 in which a series of one or more modular lighting structures are located. The signals may include, by way of example not by limitation, signals with codes or instructions for controlling a designated function for one or more associated LED arrays, such as a dimming function or other functional effects such as strobe lighting, color changes, and which may also include signals for changing or switching the state of one or more of such functions or functional effects and the like, so as to enable the grid lighting network to provide a changeable and/or enhanced environment.

At least one pair of first modular junction structures 280, 282 (for example as may be commercially available from MOLEX as can be seen at //www.molex.com/) may be associated with the at least one transfer structure 274, so that each of first modular junction structures 280, 282 may be accessible adjacent a corresponding end region 276, 278, or otherwise accessible between the respective end regions 276, 278. In this example, each first modular junction structure 280, 282 may be configured to be in power and/or signal transferring relation with another transfer structure, such as the transfer structure 284 of adjacent (or neighbouring) modular lighting segment structure 272 with a corresponding first modular junction structure 287, via a jumper structure (or interconnection structure) 286 (coupled between the first modular junction structures 282 and 287) or a supply line, such as that shown at 288 to supply line voltage power and/or signals.

At least one group of one or more first transfer channels 290 (FIG. 35) may extend along the transfer structure 274 between, and may be configured to be power and/or signal transferring relation with, one or more, in this case both of the first modular junction structures 280, 282 (for example by way of contact point structures as can be seen in FIG. 35 at 280a, 282a), while one or more of the first transfer channels 290 may be configured to be in power and/or signal transferring relation with other structures directly or indirectly associated with the transfer structure 274 such as power and/or signal receiving or transmitting structures.

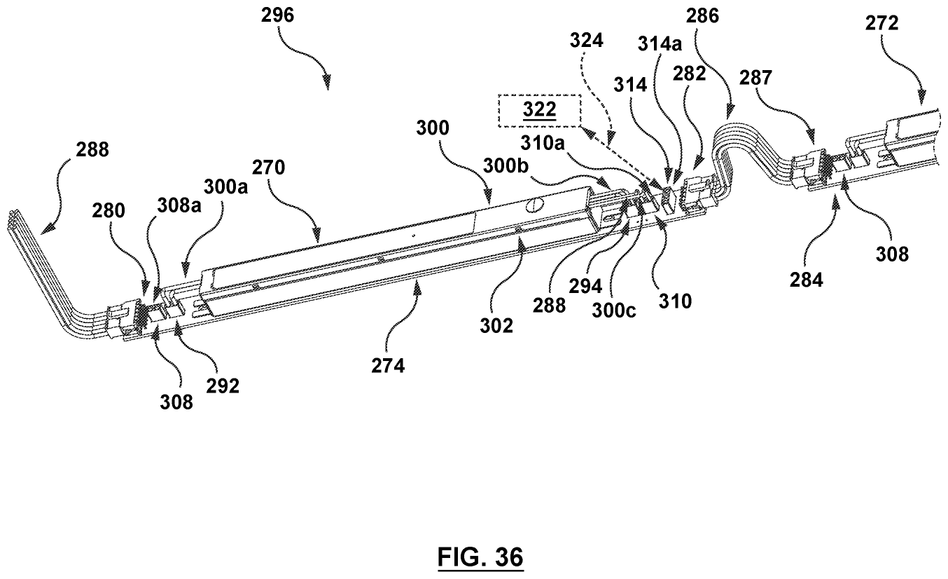

Referring to FIGS. 35 and 36, one or more, in this case two first modular sub-junction structures 292, 294 (for example as may be commercially available from AVX as may be seen at https://www.kyocera-avx.com/) may also be provided, in which each or both may be directly or indirectly in power transferring relation with one or more of the following elements:
a corresponding one or more of the at least one group of first transfer channels 290;
a first modular lighting structure or a first lighting accessory to be associated with the modular lighting segment structure 270, for example as shown generally at 296, or one or more adjacent modular lighting segment structures;
the supply line 288 (for example via the one or more of the at least one group of first transfer channels 290); and
another structure either onboard or offboard the modular lighting segment structure 270.

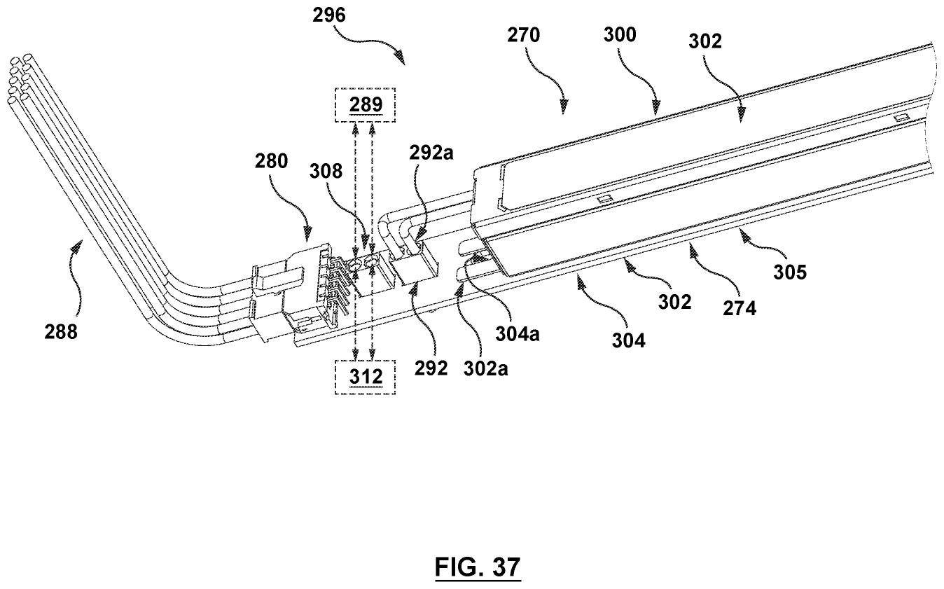

In the example of FIGS. 35 to 37, a first modular lighting structure may be provided at 296, and may include at least one driver structure 300 with a housing structure 302 to be associated with, such as by being positioned or installed on, the transfer structure 274, so that the driver structure 300 may be in power and/or signal transferring relation with one or more of the first modular sub-junction structures 292, 294. The driver structure 300 may take the form of any one of the driver structures provided or configured as described herein, such as a constant current driver 76 or constant voltage driver 78 shown above in FIG. 5, and may thus be configured to deliver low voltage power to one or more of the first transfer channels 290, that are designated accordingly. For example, the first modular sub-junction structure 292 may receive line voltage power from the first modular junction structure 280, thus providing a supply structure such as a line power supply to the driver structure 300, by way of input line voltage power lines shown at 300a, which is shown to be coupled with an output structure 292a (FIG. 37) on first modular sub-junction structure 292. Output structures is also provided on the first modular sub-junction structure 294, as well as the second and third modular sub-junction structures 308, 310 and 314, as can be seen in the figures, respectively at 308a, 310a and 314a.

Referring to FIGS. 35 and 37, the transfer structure 274 may include at least one printed circuit board structure or board structure 304, so that the at least one group of first transfer channels 290 may be in the form of conductive pathways printed or otherwise applied or adjacent thereto. The housing structure 302 of driver structure 300 or other configurations of a driver structure without a housing, may be installed on (or otherwise associated or integrally formed with) the board structure 304 in a number of ways, such as by way of fasteners (not shown) extending through passages 304a, to engage a pair of tabs 302a extending from the housing structure 302.

The modular lighting segment structure 270 may further include at least one group of one or more second transfer channels 306 (FIG. 35) to extend along the transfer structure 274, so as to be in power and/or signal transferring relation with one or both of the first junction structures 280, 282, while one or more of the second transfer channels 306 may be configured to be in power and/or signal transferring relation with other structures directly or indirectly associated with the transfer structure 274 such as power and/or signal receiving or transmitting structures.

The modular lighting segment structure 270 may further include at least two second sub-junction structures 308, 310 (FIG. 36), while the first and second transfer channels 290, 306 may be configured to enable the conductive pathways to be accessed by the first and second modular sub junction structures 280, 282 and 292, 306 respectively, or others as needed. For example, the second sub-junction structures 308, 310 may be in transferring relation with one or more of the following elements:
a corresponding group of one or more of the first and/or second transfer channels 290, 306;
a second modular lighting structure, or a second lighting accessory to be associated with the lighting segment structure, for example as shown schematically at 312 (FIG. 37), or one or more adjacent modular lighting segment structures;
the supply line 288 (directly or indirectly, for example via the one or more of the at least one group of first and/or second transfer channels 290, 306); and
any one of the elements listed above in respect of the first modular junction structures 292, 294, or another structure either onboard or offboard the modular lighting segment structure 270 or 272.

In the example embodiment of FIG. 36, the driver structure 300 may include a pair of output power lines 300b which may be in power transfer relation with the first modular sub-junction structure 294, to deliver low voltage power to LED array 322 via a third modular sub-junction structure 314 and conductive path 324. The driver structure 300 may also include a pair of signal lines 300c which may be in signal transfer relationship with the second modular sub-junction structure 310 to receive signals appearing, in this example, on two of the first and/or second transfer channels 290, 306, via the supply line 288. Thus, in this case, the second modular sub-junction structure 294 may be in power transfer relation with the third modular sub-junction structure 314, as will be described, to deliver the low voltage power to the LED array 322 via conductive path 324, as well as by way of one or more first and/or second transfer channels designated to carry low-voltage power from the driver structure 300 to one or more LED arrays associated with one or both of the modular lighting segment structures 270, 272, or others as may be provided in association therewith.

Thus, the first modular lighting structure 296 and/or second modular lighting structure 312 may include at least one first and/or second driver structure, such as for example the driver structure 300, wherein each may include a housing structure such as for example housing structure 302, to be associated, for example, with a corresponding transfer structure, wherein the first and/or second driver structures may be in power transferring relation respectively with one or more of the first and/or second sub-junction structures, for example those shown at 292, 294 and 308, 310 respectively, or one or more adjacent modular lighting segment structures.

The modular lighting segment structures 270, 272 may provide a number of options for configuring a corresponding lighting module to be installed in a grid lighting system or network, by enabling the assembler to configure each individual modular lighting structure as required. In the example of modular lighting segment structure 270, selected ones of first and second transfer channels 290, 306 may be in communication with each of the first modular junction structures 280, 282, so as to supply a common line voltage power level, a common neutral and/or signals directly or indirectly, for example either by the supply line 288, in the exemplified instance to be supplied to modular lighting segment structure 270, or by way of the jumper structure 286 to be supplied to the modular lighting segment structure 272.

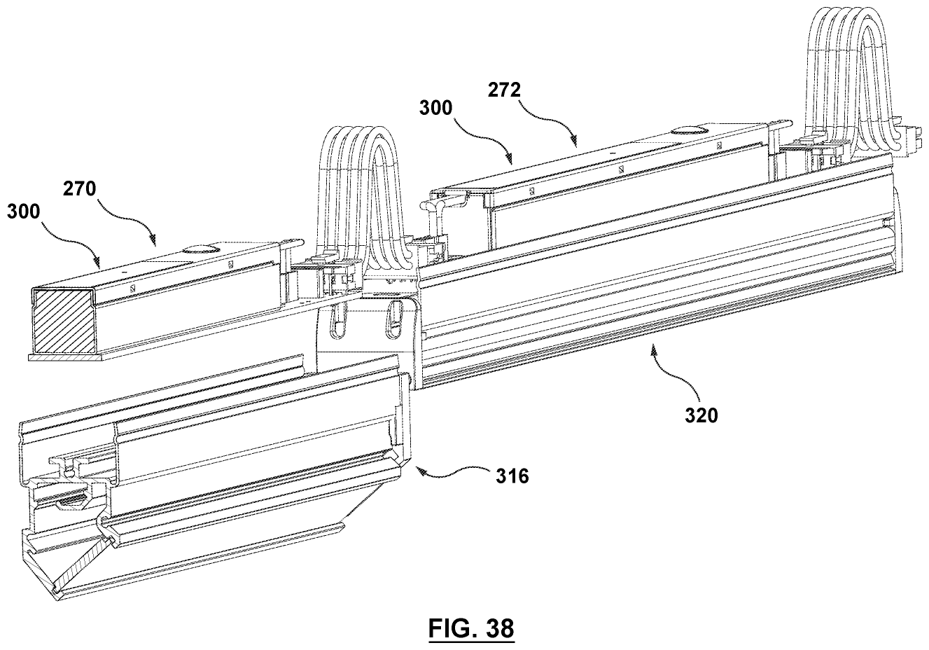

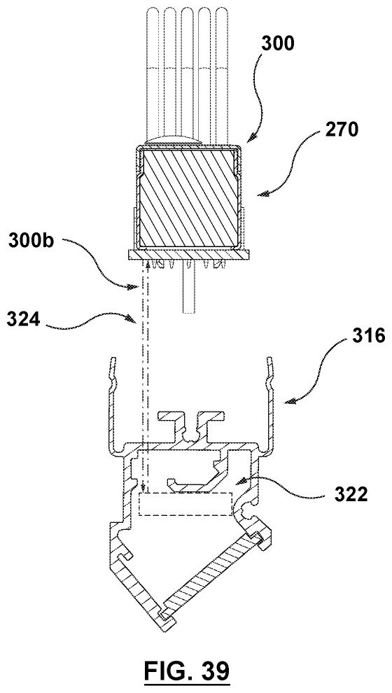

Referring to FIGS. 38 and 39, each of the modular lighting segment structures 270 and 272 may be associated with housing structures 316, 320 respectively, to support one or more LED arrays such as shown schematically at 322 in FIG. 39, to receive low voltage power from the driver structure 300, for example by way of one or more conductive paths, for example, or, as may be provided by cabling, wires or the like, as shown schematically at 324, as part of two or more lighting structures to be installed in a grid lighting network (such as shown at 225 in FIG. 23). The driver 300 shown in FIGS. 38 and 39 in cross section for easy of illustration even though it contains specific components, elements, and structures which may be contained in a potted assembly to provide the driver function. In some example embodiments, the modular lighting segment structures 270, 272 may be joined to (or associated with) one another end to end, or in other configurations as desired, to form a modular assembly of a lighting structure to be located in a designated location in a grid lighting network or structure and configured to receive line power and/or other signals, directly or indirectly from at least one single line voltage supply line.

In some example embodiments, as shown in FIG. 36, the one or more third sub-junction structures 314 may thus be provided, to be in transferring relation with any of the elements listed above for the first and/or second sub-junction structures. The third modular sub-junction structure 314 may thus be configured for transferring relation with one or more LED arrays, such as the LED array 322 in FIG. 39, by configuring the third modular sub-junction structure 314 to be coupled with the output power lines 300b, via one or more of the first or second transfer channels 290, 306 in connection with the second modular junction structure 294, to deliver low voltage power to the LED array 322.

In some example embodiments, the first, second or third modular sub-junction structures may be configured to be in transferring relation with one or more transfer channels which may not necessarily be provided on a corresponding transfer structure. In some example embodiments, the transfer structure maybe configured to be in transfer relation with a common ground with a lighting structure or accessory, or in low voltage power transfer relation with a corresponding driver structure, in which the common ground or low voltage power supply may extend to a transfer channel not associated with or a member of either the first or second groups. In some example embodiments, more than two groups of transfer channels may be provided where each group may have more than two transfer channels as illustrated, for example purposes only, in FIG. 35.

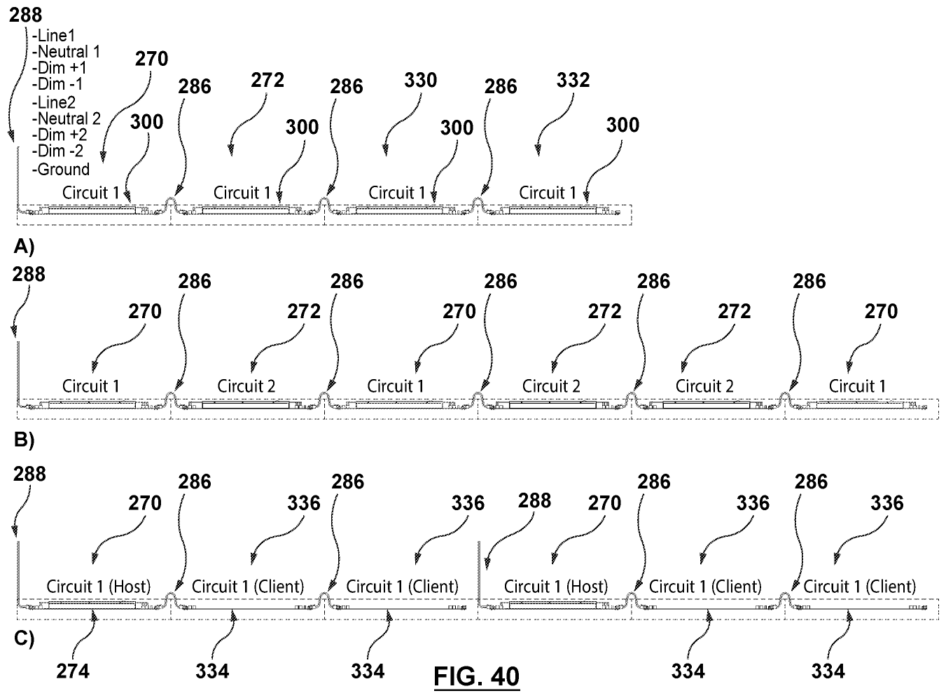

FIG. 40 illustrates three different example configurations, among other possible configurations, deploying example embodiments of the modular lighting segment structure (MLSS). In the configuration shown in configuration 40A), MLSSs 270 and 272 are in series with two additional MLSSs 330 and 332 which may be structurally and/or operationally equivalent thereto, or may have other operational features not found in, or deployed by MLSSs 270 and 272. In this case, each of the subject MLSSs may be configured to establish an equivalent circuit 1, in which power may be delivered from the line voltage power supply (or supply line) 288, and progressively through the first transfer channels, in this case as power transfer channels, not shown, and jumper structures 286 from one MLSS to another.

The line power supply 288 may, in this instance, be a 9 line supply, providing a number of power lines and signal lines, including for instance those identified as Line 1, Neutral 1, Dim +1, Dim −1, Line 2, Neutral 2, Dim +2, Dim −2, and Ground. In some example embodiments, each of the jumper structures 286 may be provided with modular junction structures on opposed end regions thereof, to establish line voltage power, low voltage and/or signal transfer relation, or a sub-combination thereof, with the corresponding modular junction structures 282 on MLSS 270 and modular junction structure 280 on MLSS 272. Alternatively, one or both end regions of the jumper structure may be integrally formed or otherwise connected to one or both of MLSS 270 and MLSS 272. Alternatively, the line voltage power supply 288 may provide other configurations in which the power supply and signal lines may involve a greater or lesser number of such supply lines. For example, the line power supply line may be configured to deliver signals without separate signal lines, by using the characteristics of the power being received on the power lines as a carrier wave for the signal. In still further configurations, signals may be delivered using other routes, such as by way of wireless signals, for example as discussed in other example embodiments herein, for example by providing wireless receiver shown schematically at 289 in FIG. 37, which may be configured to be signal transfer relation with one or more of the first and second transfer channels, as shown in one example, where the wireless receiver may be operatively coupled with second modular sub-junction structure 308, as an alternative to the second modular lighting fixture 312.

Meanwhile, each MLSS may be provided with a driver structure 300, enabling driver structure output power to be delivered to one or more LED arrays (not shown) associated with each respective MLSS. In this case, each of the subject MLSSs may be also configured to transfer signals, so that such signals may be delivered from the supply line 288, and progressively through the first transfer channels, and jumper structures 286 from one MLSS to another.

While the MLSS 270, 272 are shown to be in series, in some cases they may be configured to be in parallel. Further, the sub-junction structure delivering line power to the driver structures may be configured to be in parallel with the first and/or second power transfer channels.

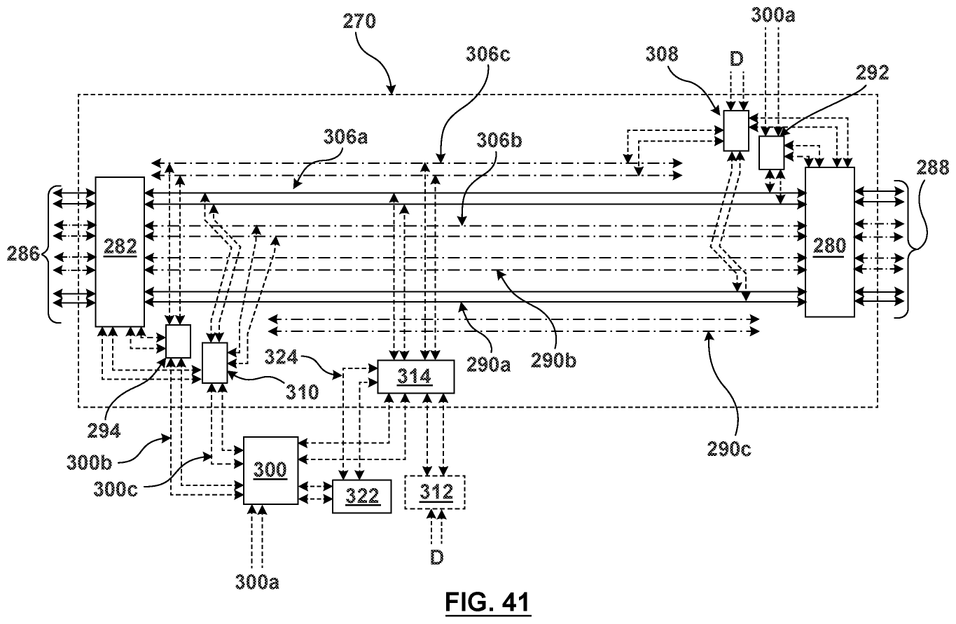

With reference to the configurations shown in FIG. 40, FIGS. 41 to 45 provide schematic representations of one or more examples of the modular lighting segment structure 270, showing some of the possible configurations thereof. Solid or dashed double or single arrow lines are provided to represent conductive paths, and in some cases are shown to cross one another, for illustration purposes only and not intended to indicate that any such crossing conductive paths in a common transferring relationship, unless indicated to the contrary. Furthermore, the solid or dashed arrow lines are intended to show a limited number of conductive path connections, including power lines and the like, and not intended to show all possible combinations of such conductive path connections. It is to be understood that any element or structure shown may, in some cases, be connected by way of a conductive path connection or to any other element or structure, when a particular configuration justifies such connections. Where one or more transfer relationships are not shown or described herein with respect to elements or structures shown in FIGS. 40 to 45, it is to be understood that any such element or structure may be so configured.

In the example of FIG. 41, with reference to FIG. 40A to C, circuit 1 or circuit 2 may include first power transfer channels 290a first signal transfer channels 290b, first low voltage power transfer channels 290c, and/or second line voltage power transfer channels 306a, second signal transfer channels 306b and second low voltage transfer channels 306c.

The first modular sub-junction structure 292 may be configured to be in power transfer relation with the first modular junction structure 280 and/or the second power transfer channels 306a.

The first modular sub-junction structure 294 may be configured to be in power transfer relation with the first modular junction structure 282 and second power transfer channels 290a (not shown). First modular sub-junction structure 294 may also be in power transfer relation with LED array 322, for example as shown in FIG. 36, via output power lines 300b, to deliver low voltage power from driver 300 via second low voltage power channels 306c, third modular subjection structure 314, and conductive paths 324.

In another configuration, the second modular sub-junction structure 308 may be configured to be in power transfer relation with the first modular junction structure 280, the first power transfer channels 290a, the driver structure 300 (not shown), and/or be in signal transfer relation with first signal channels 290b (not shown).

The second modular sub-junction structure 310 may be configured to be in power transfer relation with the first modular junction structure 282, the power transfer channels 306a, the driver structure 300 as shown by lines 300c, and/or be in signal transfer relation with second signal channels 306b.

Further, the second modular sub-junction structure 308 may be configured to be in power signal transfer relation with either the driver structure 300 via output power line 300b, first modular junction structure 294, voltage power transfer channels 306c, and the second modular lighting structure 312 via conductive path D.

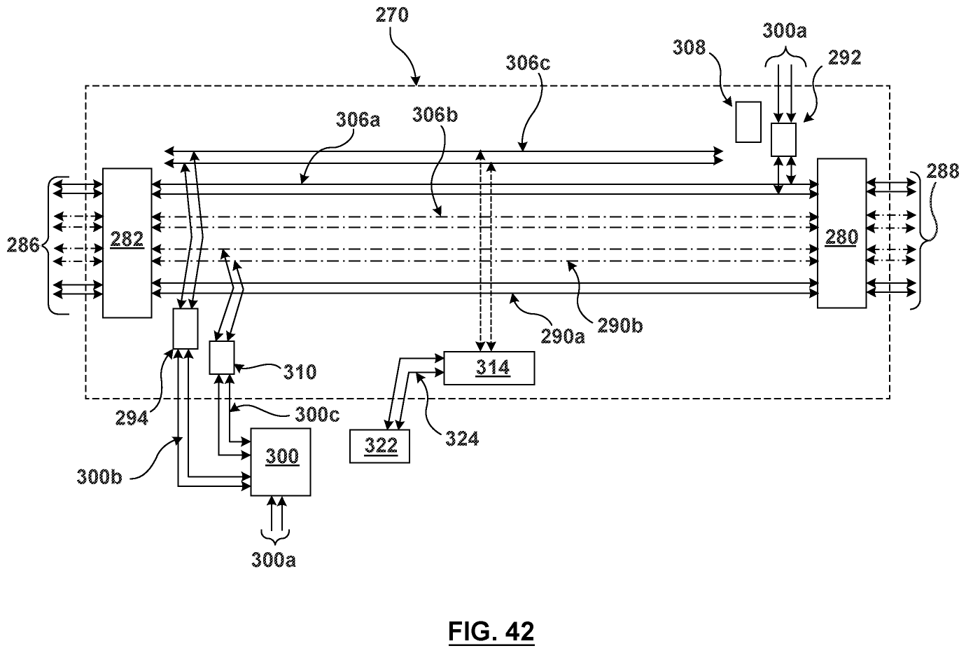

FIG. 42 provides a schematic representation of a number of example configurations, including configuration 40A and FIG. 36, of MLSS 270 and/or MLSS 272. In this case, the first modular sub-junction structure 292 may be in power transfer relation with the first modular junction structure 280 indirectly via first line voltage transfer channels 306a, and the driver structure 300 via input power line 300a. The first modular sub-junction structure 294 may be in low voltage power transfer relation with the driver structure 300 and the LED array 322, via second low voltage power transfer channels 306c, third modular junction structure 314 and conductive path 324. Meanwhile, the second modular sub-junction structure 310 may be in signal transfer relation with the first signal transfer channels 290b and/or the driver structure 300 via signal lines 300c, and/or available for a power or signal transfer relationship with another element or structure as described herein.

FIG. 40B shows a variant, in which a series of six MLSSs configured with line power being delivered throughout. In this configuration, the MLSSs 270, 272 may be configured differently to form two different circuit configurations, for example to yield two different operating conditions arising from the two different circuit, driver or signal configurations such as settings and the like. This may be achieved, for example, by deploying the driver structure 300 in the first circuit by way of the first power transfer channels 290 (not shown), whereas a second circuit configuration may deploy a different driver structure configuration, or another lighting accessory via the second power transfer channels 306 (not shown).

In the configuration shown in FIG. 40C), two line voltage power sources 288 may be provided to deliver line power to each of two groups of MLSSs, including MLSS 270 where it assumes a host or server role by providing driver structure output power via the power transfer structure 274, such as by way of first and/or second power transfer channels 290, 306 to a respective power transfer structure 334 in each of one or more client MLSSs 336, via jumper structures 286 along the series of client MLSSs 336. In this instance, each of client MLSSs 336 may not be provided with a driver structure 300, though they may be provided with other configurations to provide additional capabilities to deliver functions to structures associated with each respective client MLSS.

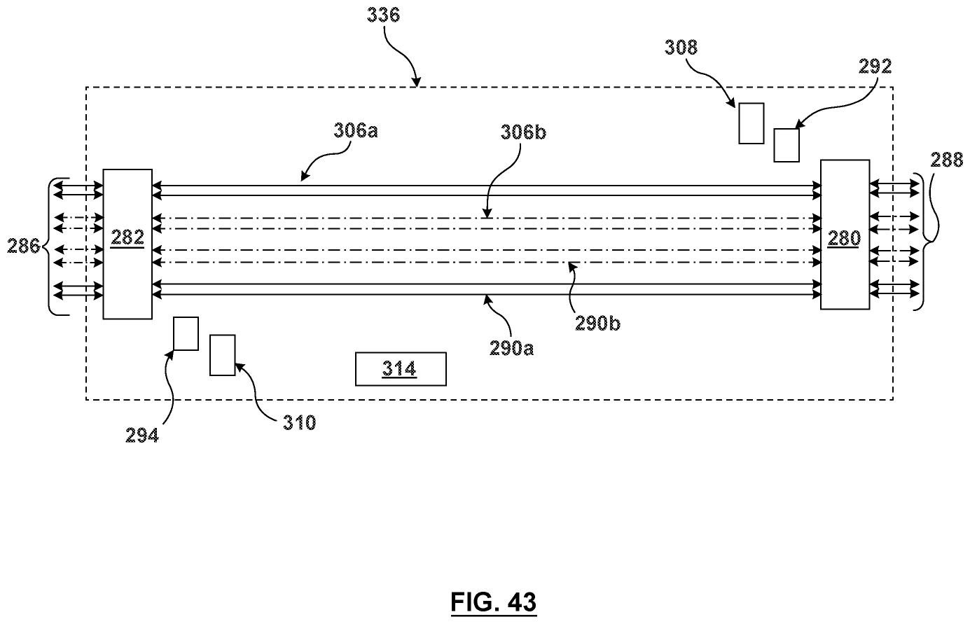

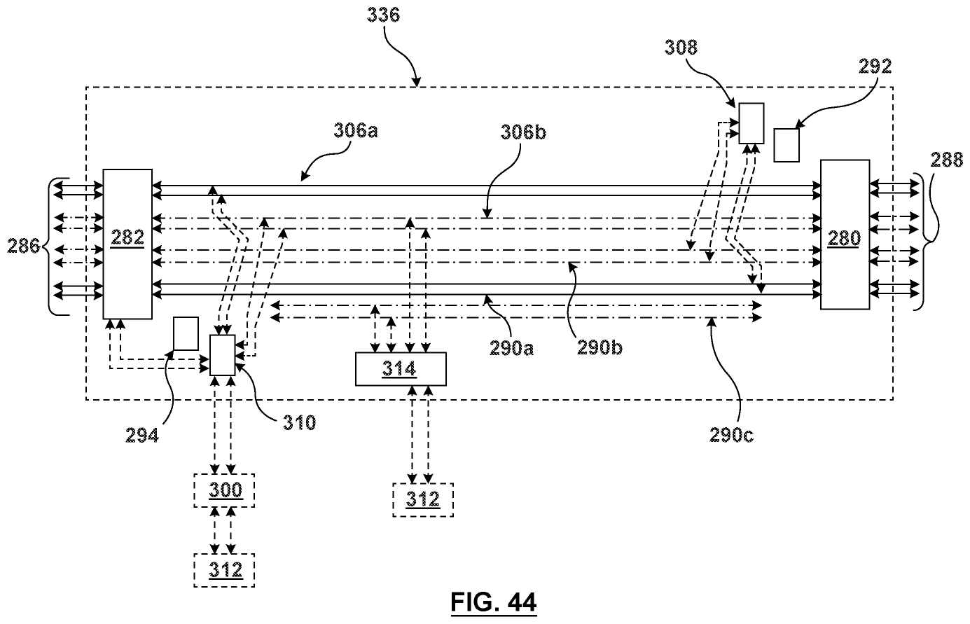

FIG. 43 provides a schematic representation of an example configuration 40C, of MLSS 336, to transfer line voltage power and/or signals from MLSS 270 to at least one MLSS 336 toward an MLSS 336 which is in low voltage power transfer, or signal relation directly or indirectly with an LED array. In this case, the first modular sub-junction structures 292, 294, the second modular sub-junction structures 308, 310, as well as the third modular sub-junction structure 314 may not be in a power or signal transfer relation with either the first or section transfer channels 290a, 290b, 306a and 306b. Meanwhile, the first modular junction structures 280 and 282 may be in power and/or signal transfer relation with the first power and signal transfer channels 290a, 290b and the second power and signal transfer channels 306a, 306b, as well as the line power supply 288 and the jumper 286 respectively. In this configuration, the MLSS 336 may perform the role of transferring line voltage power (or low voltage power by way of low voltage power transfer channels (not shown) and signals to a downstream MLSS 336, for example as may be shown in FIG. 44, in which the second modular sub-junction structure 308 may be in a power or signal transfer relation with either the first line voltage power or signal transfer channels 290a, 290b, while the second sub-junction structure 310 may be in a power or signal transfer relation with line voltage power or signal transfer channels 306a and 306b, or with first modular junction structure 282, so as to deliver line voltage power and/or signals to driver structure 300. Meanwhile, or alternatively, the third sub-junction structure 314 may be configured to be in a low voltage power transfer relation with low voltage power transfer channels 290c, or in signal transfer relation with first signal transfer channels 306b to deliver low voltage power and/or signals to LED array 312.

Thus, in the configurations of FIGS. 40A) and 40B) the series of MLSSs have the effect of forming, together with the associated one or more LED arrays, a composite lighting module for installation in a grid lighting network, while in the configuration of FIG. 40C) the series of MLSSs have the effect of forming, together with the associated one or more LED arrays, two composite lighting modules for respective installation in the grid lighting network, where a single driver structure may be deployed to deliver driver structure output power to a lighting structure, such as a modular lighting structure, or a lighting accessory, for example one or more LED arrays and the like, that are downstream from the driver structure and its associated MLSS, yet still in a common lighting module for installation in a grid lighting system.

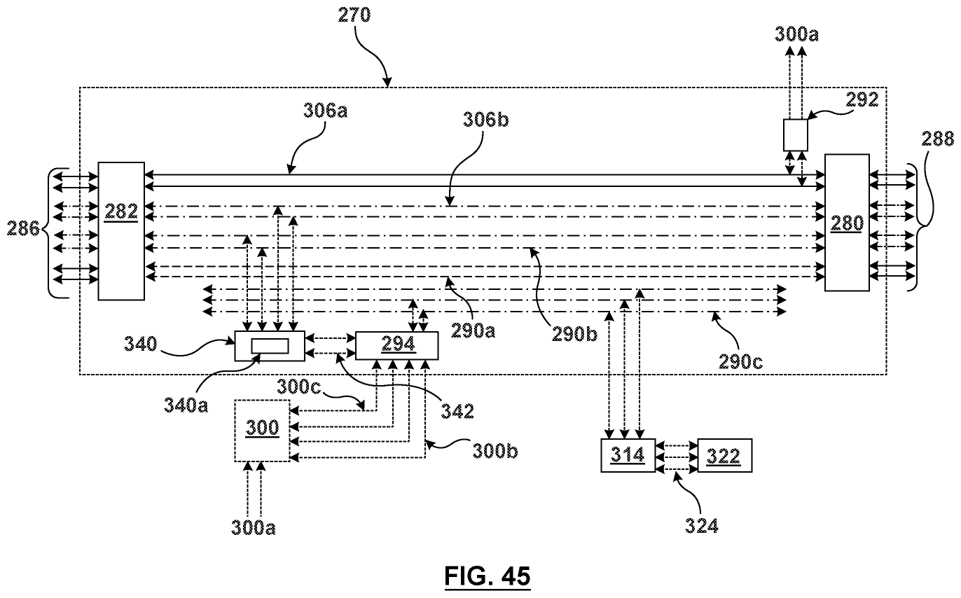

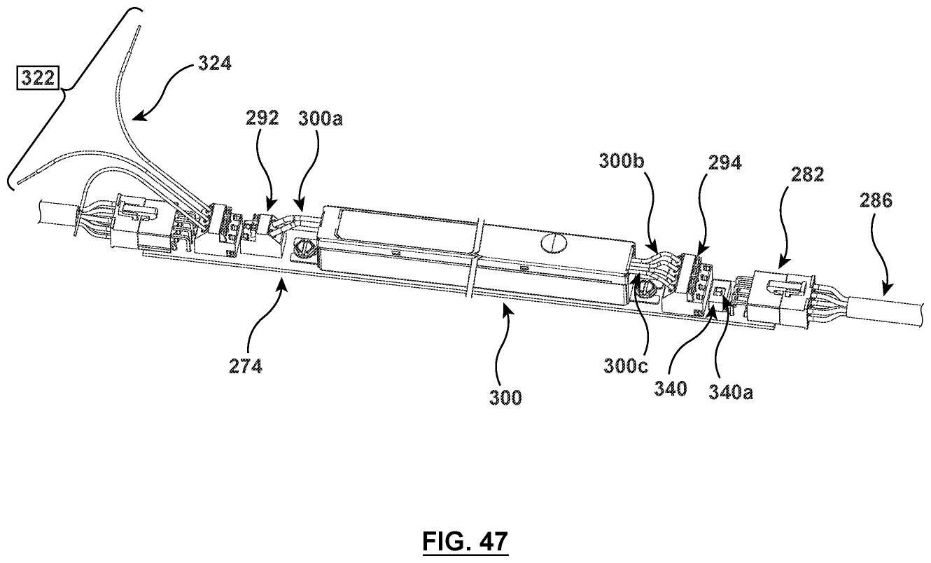

FIGS. 45 and 46 to 48 show a variation of the configuration of FIG. 40A, of the MLSS 270, in which the modular sub-junction structure 292 may be in a power transfer relation with line voltage power transfer channels 306a to deliver line power to the driver structure 300 via input power lines 300a, and thus to deliver low voltage on output power lines 300b to modular sub-junction structure 294, which is in turn in low voltage power transfer relation with low voltage power channels 290c. Meanwhile, modular sub-junction structure 314 may be in low voltage power transfer relation with the low voltage power channels 290c to deliver low voltage power (together with a common ground) to the one or more LED arrays 322 via conductive path 324.

Also provided is a switch structure shown at 340 which may be in communication signal transfer relation with communication channels 290b and 306b via contact structures 340b, and operable to change state according to the position of the switch actuator structure 340a. The switch structure 340 may also control or designate the communication signal transfer relation with the modular sub-junction structure 294, by way of communication signal lines 342 to exchange communication signals therewith from the corresponding communication channels 290b or 306b according to the position of the switch actuator structure 340a to the driver structure 300 via communication signal lines 300c. This, the switch structure 240 may be configured to change an operational mode of the driver structure 300 according to the communication signal details exchanged with the corresponding communication channel 290a, 306b.

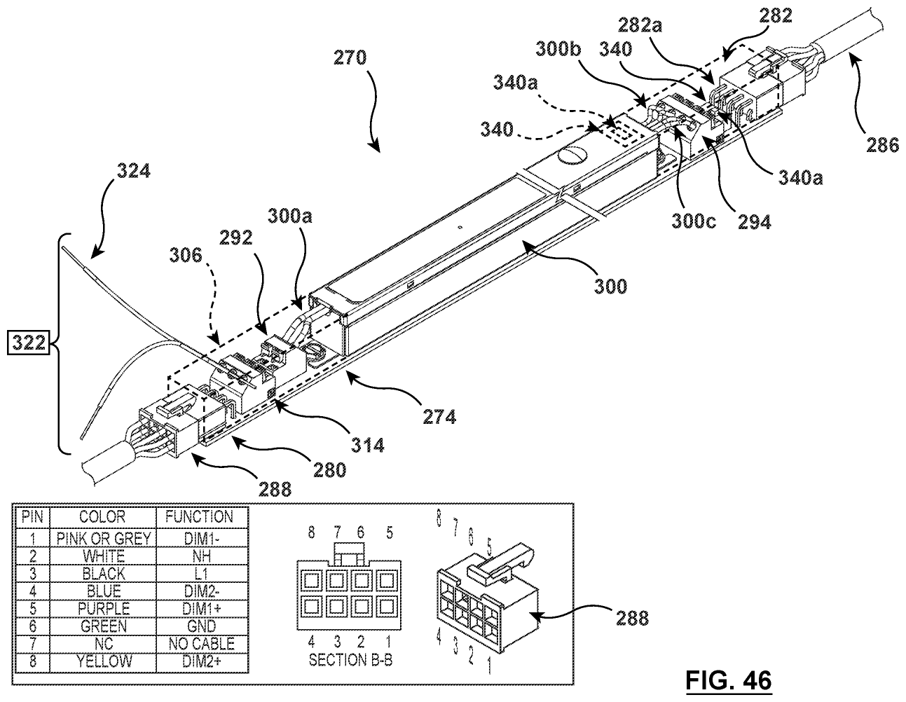

FIGS. 46 to 48 illustrate the example embodiment of FIG. 45, with reference numbers corresponding to those structures that have at least some common aspects as those shown in the example embodiment of FIGS. 35 to 39. The modular lighting segment structure 270 may be configured to deliver line voltage power, low voltage power and/or communications signals to one or more lighting modules, when operable in a corresponding one or more mounting sectors in a grid lighting system.

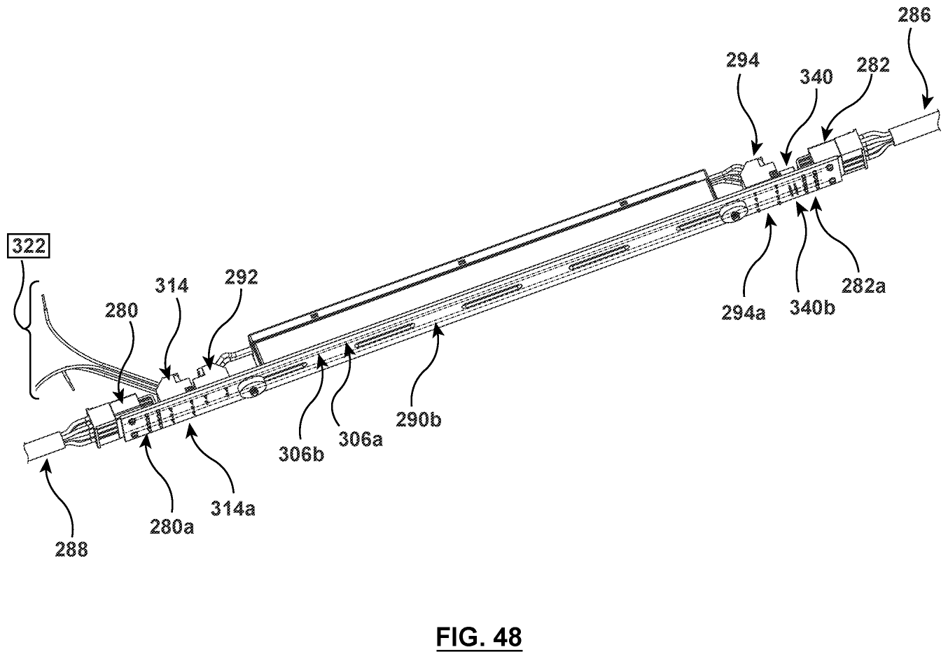

At least two modular junction structures 280, 282 may be provided, each configured to be accessible adjacent a respective end region of transfer structure 274, with a plurality of contact structures, for example as shown at 280a, 282a, to be in power and/or communications signal transferring relation with corresponding transfer channels, selections of which are schematically identified at 290b, 306a and 306b in FIG. 48. Each of the at least one pair of modular junction structures 280, 282 may be configured to be in direct or indirect line voltage power and/or communications signal transferring relation with at least one of a modular junction structure on a transfer structure of at least one of an adjacent modular lighting segment structure, for example by way of jumper structure 286, and an adjacent power and/or communications signal supply structure 288, such as a supply cable, associated with at least one of the mounting sectors. In this example embodiment, the modular junction structure 280 may be configured to receive line voltage power from the line voltage power supply 288, which may be at a range of about 2500 W at 277V to about 1080 W at 120V, though it is to be understood that other voltage levels and/or power levels may apply in some instances.

The transfer structure 274 may include at least one printed circuit board structure or board structure so that the at least one group of first transfer channels may be in the form of conductive pathways printed or otherwise applied or adjacent thereto. The housing structure driver structure 300 or other configurations of a driver structure without a housing, may be installed on (or otherwise associated or integrally formed with) the board structure, and may include one or more of the structures, elements and functions in the disclosure and figures herein. In some examples, the housing structure (as shown schematically in dashed lines at 306) may extend toward and enclose, at least in part, each of the modular junctions 280, 282 and modular sub-junction structures 292, 294 and 314, as well as the switch structure 340 and switch actuator structure 340a, while retaining accessibility to each of the enclosed components externally, as required, such as to the first modular sub-junction structures 280, 282 by the jumper structure 286 and line voltage power supply 288. In an example embodiment (as shown schematically in dashed lines at 340, 340a on the housing structure 306), the switch actuator structure 340a may be accessible externally of the housing structure 306, for the purposes of manual switching thereof, or may otherwise configured to be operational through signal-based instructions to initiate switching thereof, by way of an onboard or remotely networked controller not shown.

Modular sub-junction structures 292, 294 and 314 may be configured to be in line voltage or low voltage power and/or communications signal transferring relation with at least one of:
a corresponding group of the plurality of transfer channels, such as shown at 290b, 306a, 306b;
at least one modular lighting structure such as shown at 322 in FIG. 46, at least one LED array associated with the corresponding lighting module, the modular lighting structure, or at least one lighting accessory to be associated with one of the one or more lighting modules;
the adjacent supply structure; and
another structure associated with the modular lighting segment structure.

The plurality of transfer channels, such as shown at 290b, 306a and 306b may be configured to be in at least one of a power transferring relation and a signal transferring relation with at least one of the of the modular junction structures, and/or at least one of the modular sub-junction structures.

In this case, at least one group of transfer channels may include at least one line voltage power transfer channel, shown at 306a, and at least two communication signal channels, shown in this case at 290b, 306b. However, the transfer channels may include a plurality of line voltage power transfer channels, a plurality of low voltage power transfer channels and a plurality of communications signal channels, as shown in FIG. 45.

At least one switching structure, such as shown at 340, may be configured to be in power and/or signal exchanging relation with at least two of the transfer channels, and to be in power and/or signal exchanging relation with:
at least one other of the plurality of transfer channels;
at least one modular lighting structure, at least one LED array associated with the corresponding lighting module, the modular lighting structure, or at least one lighting accessory to be associated with one of the one or more lighting modules;
the adjacent supply structure;
a driver structure; and
another structure associated with the modular lighting segment structure.

The switching structure 340 may be further configured to be in signal exchanging relation with at least two transfer channels, for instance as shown at 290b, 306b, and the driver structure 300, to deliver communications thereto, according to a corresponding transfer channel according to an operational position of the switch structure.

While the present disclosure describes various example embodiments, the disclosure is not so limited. To the contrary, the disclosure is intended to cover various modifications and equivalent arrangements, as will be readily appreciated by the person of ordinary skill in the art.

1. A modular lighting segment structure for use in assembling in a series of at least two thereof for a grid lighting system, comprising:
at least one transfer structure extending along a length dimension thereof, the at least one transfer structure having at least two end regions;
at least one pair of first modular junction structures associated with a corresponding one of the at least one transfer structure and in power transferring relation therewith, wherein each one of the at least one pair of first modular junction structures is accessible adjacent the transfer structure, and is configured to be in power transferring relation with a modular junction structure on a transfer structure of at least one of an adjacent modular lighting segment structure and an adjacent supply structure;
at least one group of first transfer channels extending along the at least one transfer structure, and configured to be in power transferring relation with, one pair of the at least one pair of first modular junction structures; and
at least one first modular sub-junction structure configured to be in power transferring relation with at least one of:
a corresponding group of the at least one group of first transfer channels to exchange line voltage power therewith;
at least one first modular lighting structure, or at least one first lighting accessory to be associated with the modular lighting segment structure;
the adjacent supply structure to receive line volage power therefrom; and
another structure associated with the modular lighting segment structure.

2. The modular lighting segment structure of claim 1, wherein one or more of the first modular junction structures are each accessible adjacent a corresponding end region.

3. The modular lighting segment structure of claim 1, wherein at least two of the at least one group of first transfer channels are configured to be in at least one of a power transferring relation and a signal transferring relation with at least one of the of the first modular junction structures.

4. The modular lighting segment structure of claim 1, wherein the at least one group of first transfer channels extends between at least one pair of the at least one pair of first modular junction structures.

5. The modular lighting segment structure of claim 3, wherein the at least one group of first transfer channels includes at least one power transfer channel and at least two signal transfer channels.

6. The modular lighting segment structure of claim 1, further comprising at least one first driver structure to be associated with one of the at least one transfer structure, wherein the at least one first driver structure is configured to be in power and/or signal transferring relation with at least one of the first modular sub-junction structures.

7. The modular lighting segment structure of claim 6, wherein the at least one transfer structure includes at least one board structure, wherein the at least one group of first transfer channels includes a plurality of conductive pathways applied to the at least one board structure.

8. The modular lighting segment structure of claim 1, wherein the at least one transfer structure is configured to transfer power and signals therealong.

9. The modular lighting segment structure of claim 8, wherein the first transfer channels include a plurality of power transfer channels and a plurality of signal transfer channels.

10. The modular lighting segment structure of claim 1, further comprising:
at least one group of second transfer channels extending along the at least one transfer structure and configured to be in power transferring relation with one pair of the at least one pair of first modular junction structures; and
one or more second modular sub-junction structures to be in power transferring relation with at least one of:
a corresponding group of the at least one group of first and/or second transfer channels,
at least one second modular lighting structure, or at least one second lighting accessory to be associated with the modular lighting segment structure, and;
another structure at least one of onboard and offboard the modular lighting segment structure.

11. The modular lighting segment structure of claim 10, wherein the at least one transfer structure includes at least one board structure, wherein at least one of the at least one group of first transfer channels and the at least one group of second transfer channels are in the form of conductive pathways applied to the at least one board structure.

12. The modular lighting segment structure of claim 11, wherein at least one of the at least one first modular lighting structure and the at least one second modular lighting structure respectively include at least one of the at least one first driver structure and at least one second driver structure configured to be associated with the at least one transfer structure, and to be in at least one of a power transferring relation and a signal transferring relation with a corresponding at least one of the first and second modular sub-junction structures.

13. A modular lighting segment structure assembly, comprising at least two modular lighting segment structures as defined in claim 1.

14. A kit to assemble a modular lighting segment assembly, comprising at least a pair of modular lighting segment structures according to claim 1, and a jumper structure, wherein:
a. a first of the pair, as a host modular lighting segment structure, is configured with a driver structure, and:
to deliver line voltage power from the adjacent supply structure to the driver structure directly or indirectly via one of the first modular junction structures thereon;
to deliver low voltage power from the driver structure to at least one LED array associated with the first modular lighting segment structure; and
to deliver the line voltage power and/or the low voltage power to second of the pair, and wherein;
b. the second of the pair, as a client modular lighting segment structure, is configured to receive at least one of the line power and the low voltage power at a first modular junction structure thereon via the jumper structure between respective first modular junction structures on the host and client modular lighting segment structures, and to deliver the low voltage power to at least one LED array associated with the host modular lighting segment structure and/or the client modular lighting segment structure.

15. The kit of claim 14, wherein the client modular lighting segment structure is configured to deliver the at least one of the line voltage power and the low voltage power to another of the first modular junction structures on the client modular junction structure, so as to transfer the at least one of the line voltage power and the low voltage power to another modular lighting segment.

16. The modular lighting segment structure of claim 1, wherein the other structure associated with the modular lighting segment structure is onboard the modular lighting segment structure.

17. The modular lighting segment structure of claim 1, wherein the other structure associated with the modular lighting segment structure is offboard the modular lighting segment structure.

18. The modular lighting segment structure of claim 1, wherein the at least two end regions are at least one of spaced apart, opposed and adjacent.

19. A modular lighting segment structure for use in multiples of least two thereof, for use in one or more lighting modules, to deliver line voltage power and/or communication signals thereto, when operable in a corresponding one or more mounting sectors in a grid lighting system, the modular lighting segment structure comprising:
at least one transfer structure having at least two end regions, and including a plurality of transfer channels extending therealong, with one or more thereof configured to transfer line voltage power and/or communications signals;
at least one pair of first modular junction structures, each configured to be accessible adjacent a respective one of the end regions, and configured to be in line voltage power and/or signal transferring relation with corresponding ones of the transfer channels, wherein each one of the at least one pair of first modular junction structures is configured to be in direct or indirect line voltage power transferring relation with at least one of a modular junction structure associated with a transfer structure of at least one adjacent modular lighting segment structure, and an adjacent line voltage power and/or communications signal supply structure associated with at least one of the mounting sectors;
at least one modular sub-junction structure configured to be in line voltage or low voltage power transferring relation with at least one of:
a corresponding plurality of the at least one group of the plurality of transfer channels;
at least one LED array associated with a corresponding lighting module, or at least one lighting accessory to be associated with the lighting module;
the adjacent supply structure; and
another structure associated with the modular lighting segment structure.

20. A modular lighting segment structure for use in multiples of least two thereof, for use in one or more lighting modules, to transfer line voltage power and/or signals therewith, when operable in a corresponding one or more mounting sectors in a grid lighting system, the modular lighting segment comprising:
at least one transfer structure with a plurality of transfer channels extending between at least two end regions thereof to transfer power and/or signals;
at least two modular junction structures, each configured to be accessible adjacent a respective end region, to be in power and/or signal transferring relation with corresponding transfer channels, wherein each one of the at least one pair of modular junction structures is configured to be in direct or indirect line voltage power and/or signal transferring relation with at least one of a modular junction structure on a transfer structure of at least one of an adjacent modular lighting segment structure, and an adjacent line voltage power and/or signal supply structure associated directly or indirectly with at least one of the mounting sectors;
at least one modular sub-junction structure configured to be in line voltage or low voltage power and/or signal transferring relation with at least one of:
a corresponding group of the plurality of transfer channels;
at least one modular lighting structure, at least one LED array associated with the corresponding lighting module or the modular lighting structure, or at least one lighting accessory to be associated with one of the one or more lighting modules;
the adjacent supply structure; and
another structure associated with the modular lighting segment structure.

21. The modular lighting segment structure of claim 20, wherein one or more of the modular junction structures are each accessible adjacent a corresponding end region.

22. The modular lighting segment structure of claim 20, wherein at least two of the plurality of transfer channels are configured to be in at least one of a line voltage power transferring relation and a signal transferring relation with at least one of the of the modular junction structures.

23. The modular lighting segment structure of claim 20, wherein at least one group of plurality of the transfer channels extends between at least two of the at least one pair of first modular junction structures.

24. The modular lighting segment structure of claim 23, wherein the at least one group of transfer channels includes at least two line voltage power transfer channels and at least two signal channels.

25. The modular lighting segment structure of claim 20, wherein the at least one modular lighting structure includes at least one driver structure to be associated with one of the at least one transfer structure, wherein the at least one driver structure is configured to be in line voltage or low voltage power and/or signal transferring relation with at least one of the first modular sub-junction structures.

26. The modular lighting segment structure of claim 20, wherein the at least one transfer structure includes at least one board structure, wherein the plurality of transfer channels includes a plurality of conductive pathways applied to the at least one board structure.

27. The modular lighting segment structure of claim 20, wherein the transfer channels include a plurality of line voltage power transfer channels, a plurality of low voltage power transfer channels and a plurality of signal channels.

28. The modular lighting segment structure of claim 20, further comprising at least one switching structure configured to be in power and/or signal exchanging relation with at least two transfer channels, and to be in power and/or signal exchanging relation with:
at least one other of the plurality of transfer channels;
at least one modular lighting structure, at least one LED array associated with a corresponding lighting module or the modular lighting structure, or at least one lighting accessory to be associated with one of the one or more lighting modules;
the adjacent supply structure;
a driver structure; and
another structure associated with the modular lighting segment structure.

29. The modular lighting segment structure of claim 20, further comprising at least one switching structure configured to be in signal exchanging relation with at least two transfer channels, and the driver structure, to deliver signals thereto, according to a corresponding transfer channel according to an operational position of the switch structure.

30. A modular lighting segment structure assembly for use in one or more lighting modules, to deliver power and/or signals thereto, when operable in a corresponding one or more mounting sectors in a grid lighting system, the modular lighting segment structure assembly comprising:
at least one transfer structure having a plurality of transfer channels extending in a zone between at least two end regions thereof and to transfer power and/or signals along at least part of the zone;
at least one modular junction structure configured to be in power and/or signal transferring relation with corresponding ones of the plurality of transfer channels, and configured to be in direct or indirect line voltage power and/or signal transferring relation with at least one of:
a modular junction structure on an adjacent modular lighting segment structure assembly, and
a line voltage power and/or signal supply structure associated with the grid lighting system;
at least one modular sub-junction structure configured to be in line voltage power transferring relation, low voltage power transferring relation and/or signal transferring relation with the at least one of the plurality of transfer channels, and/or directly or indirectly with the at least one modular junction structure or the one or more lighting modules.

31. The modular lighting segment structure assembly of claim 30, wherein the at least one modular junction structure includes at least two modular junction structures, each configured to be accessible adjacent a respective end region of the at least one transfer structure.

32. The modular lighting segment structure assembly of claim 30, wherein the plurality of transfer channels includes a first group of transfer channels configured to be in line voltage power transferring relation directly or indirectly with one of the at least one modular junction structure.

33. The modular lighting segment structure assembly of claim 30, wherein the plurality of transfer channels includes a second group of transfer channels configured to be in low voltage power transferring relation directly or indirectly with at least one of the at least one modular junction structure, the least one modular sub-junction structure and the one or more lighting modules.

34. The modular lighting segment structure assembly of claim 30, wherein the plurality of transfer channels includes a third group of transfer channels configured to be in signal transferring relation directly or indirectly with at least one of the at least one modular junction structure, the least one modular sub-junction structure and the one or more lighting modules.

35. The modular lighting segment structure assembly of claim 30, wherein the plurality of transfer channels includes a first group of transfer channels configured to be in line voltage power transferring relation directly or indirectly with the at least one modular junction structure; a second group of transfer channels configured to be in low voltage power transferring relation directly or indirectly with at least one of the at least one modular junction structure, the least one modular sub-junction structure and the one or more lighting modules; and a third group of transfer channels configured to be in signal transferring relation directly or indirectly with at least one of the at least one modular junction structure, the least one modular sub-junction structure and the one or more lighting modules.

36. The modular lighting segment structure assembly of claim 35, wherein at least one transfer channel of the plurality of transfer channels is a member of one or more of the first, second and third groups.

37. The modular lighting segment structure of claim 30, further comprising at least one switching structure configured to be in signal exchanging relation with at least two transfer channels, and the driver structure, to deliver signals thereto, according to a corresponding transfer channel according to an operational position of the switch structure.

38. A modular lighting segment structure assembly for use in one or more lighting modules, to deliver power and/or signals thereto, when operable in a corresponding one or more mounting sectors in a grid lighting system, the modular lighting segment structure assembly comprising:
at least one transfer structure having a plurality of transfer channels extending in a zone between at least two end regions thereof and to transfer power and/or signals along at least part of the zone;
at least one modular junction structure configured to be in power and/or signal transferring relation with corresponding ones of the plurality of transfer channels, and configured to be in direct or indirect line voltage power and/or signal transferring relation with at least one of:
a modular junction structure on an adjacent modular lighting segment structure assembly, and
a line voltage power and/or signal supply structure associated with the grid lighting system;
at least one modular sub-junction structure configured to be in line voltage power transferring relation, low voltage power transferring relation and/or signal transferring relation with the at least one of the plurality of transfer channels, and/or directly or indirectly with the at least one modular junction structure, and at least one output structure for delivery of the line voltage power transferring relation, low voltage power transferring relation and/or signal thereto.

39. A lighting module comprising the modular lighting segment structure of claim 38.

40. An LED assembly comprising the modular lighting segment structure of claim 38.
